(19) United States
(12) Patent Application Publication
(10) Pub. No.: US 2026/0355675 A1
(43) Pub. Date: Nov. 12, 2026

(54) DUAL MODE CARBON CAPTURE CHAMBER AND METHODS OF DUAL MODE CARBON CAPTURE

(71) Applicant: Provocative Science Holdings, Inc., Somerville, MA (US)

(72) Inventors: Nicholas Meyer, Boston, MA (US); Andrew Bouma, Cambridge, MA (US); Bryan Woodruff, Medford, MA (US); Indrid Xhuti, Watertown, MA (US)

(73) Assignee: Provocative Science Holdings, Inc., Somerville, MA (US)

(21) Appl. No.: 19/674,584

(22) Filed: May 12, 2026

Related U.S. Application Data
(60) Provisional application No. 63/804,133, filed on May 12, 2025.

(51) Int. Cl. B01D 53/04; B01D 53/26

(52) U.S. Cl. CPC B01D 53/0462; B01D 53/0438; B01D 53/0446; B01D 53/0454; B01D 53/261; B01D 2257/504; B01D 2257/80; B01D 2259/40003; B01D 2259/40007

(57) ABSTRACT

A dual mode carbon capture chamber and methods of dual mode carbon capture are disclosed. The chamber includes an exterior wall, a carbon capture structure with an adsorbent material, a selectively sealable air intake, a selectively sealable air exhaust, a temperature control system, and a vacuum system. The vacuum system operates in two modes: a first mode to remove non-carbon dioxide gas while carbon dioxide remains adsorbed, and a second mode to remove released carbon dioxide after heating the carbon capture structure. The temperature control system heats the carbon capture structure to release adsorbed carbon dioxide. The chamber enables efficient carbon capture and separation from air, with potential applications in various industries.

### CROSS-REFERENCE TO RELATED APPLICATIONS

This application claims the benefit of priority of U.S. Provisional Patent Application Serial No. 63/804,133, filed on May 12, 2025, and titled “DUAL MODE CARBON CAPTURE CHAMBER,” which is incorporated by reference herein in its entirety.

### FIELD OF THE INVENTION

The present invention generally relates to the field of carbon capture. In particular, the present invention is directed to a dual mode carbon capture chamber and methods of dual mode carbon capture.

### BACKGROUND

Carbon capture, utilization, and storage technologies can capture carbon dioxide at the source or directly from air, enabling it to be reused for industrial or consumer applications. Current systems used to capture carbon dioxide are inefficient in terms of energy consumption and other factors.

### SUMMARY OF THE DISCLOSURE

In an aspect, a dual mode carbon capture chamber is disclosed. The chamber includes at least an exterior wall defining an interior of the chamber, a carbon capture structure disposed within the interior of the chamber, wherein the carbon capture structure includes an adsorbent material configured to adsorb carbon dioxide from air received in the chamber, a selectively sealable air intake configured to permit the air to enter the chamber during a carbon capture state, a selectively sealable air exhaust configured to permit gas to exit the chamber, a temperature control system thermally coupled to the carbon capture structure, wherein the temperature control system is configured to heat the carbon capture structure, and a vacuum system in fluid communication with the interior of the chamber, wherein the vacuum system is configured to operate in a first vacuum mode and a second vacuum mode, wherein the vacuum system is configured, in the first vacuum mode, to remove non-carbon dioxide gas from the interior of the chamber while the carbon dioxide remains adsorbed by the adsorbent material, and the vacuum system is configured, in the second vacuum mode, to remove the carbon dioxide released from the adsorbent material after the carbon capture structure is heated by the temperature control system.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates an exemplary embodiment of a dual mode carbon capture chamber;

FIG. 2 illustrates an example embodiment of a partially sectional view of a carbon capture chamber;

FIG. 3 illustrates a state diagram illustrating the operational states of a dual mode carbon capture chamber;

FIG. 4 illustrates an exemplary embodiment of an active carbon capture system;

FIG. 5 illustrates a flow diagram of an exemplary method of operating a dual mode carbon capture chamber; and

FIG. 6 illustrates a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to a dual mode carbon capture chamber. The chamber includes at least an exterior wall defining an interior of the chamber, a carbon capture structure disposed within the interior of the chamber, wherein the carbon capture structure includes an adsorbent material configured to adsorb carbon dioxide from air received in the chamber, a selectively sealable air intake configured to permit the air to enter the chamber during a carbon capture state, a selectively sealable air exhaust configured to permit gas to exit the chamber, a temperature control system thermally coupled to the carbon capture structure, wherein the temperature control system is configured to heat the carbon capture structure, and a vacuum system in fluid communication with the interior of the chamber, wherein the vacuum system is configured to operate in a first vacuum mode and a second vacuum mode, wherein the vacuum system is configured, in the first vacuum mode, to remove non-carbon dioxide gas from the interior of the chamber while the carbon dioxide remains adsorbed by the adsorbent material, and the vacuum system is configured, in the second vacuum mode, to remove the carbon dioxide released from the adsorbent material after the carbon capture structure is heated by the temperature control system.

Exemplary embodiments illustrating aspects of the present disclosure are described below in the context of several specific examples.

At a high level, aspects of the present disclosure are directed to systems for a dual mode carbon capture chamber. The chamber includes at least an exterior wall defining an interior of the chamber, a carbon capture structure disposed within the interior of the chamber, wherein the carbon capture structure includes an adsorbent material configured to adsorb carbon dioxide from air received in the chamber, a selectively sealable air intake configured to permit the air to enter the chamber during a carbon capture state, a selectively sealable air exhaust configured to permit gas to exit the chamber, a temperature control system thermally coupled to the carbon capture structure, wherein the temperature control system is configured to heat the carbon capture structure, and a vacuum system in fluid communication with the interior of the chamber, wherein the vacuum system is configured to operate in a first vacuum mode and a second vacuum mode, wherein the vacuum system is configured, in the first vacuum mode, to remove non-carbon dioxide gas from the interior of the chamber while the carbon dioxide remains adsorbed by the adsorbent material, and the vacuum system is configured, in the second vacuum mode, to remove the carbon dioxide released from the adsorbent material after the carbon capture structure is heated by the temperature control system.

In an aspect, conventional carbon capture chambers may be inefficient in achieving high-purity carbon dioxide recovery, because of the presence of multiple gas components in air and the presence of water vapor. During a carbon capture process, water vapor may be co-adsorbed or co-absorbed along with carbon dioxide by carbon dioxide capture material, which may reduce the purity and efficiency of carbon dioxide recovery. Additionally, extracting carbon dioxide from a gas mixture without significant loss of yield remains a technical challenge. To address these issues, embodiments presented in the present disclosure provide a dual mode carbon capture chamber configured to improve both carbon dioxide yield and the purity of collected carbon dioxide. In one or more embodiments, the dual mode carbon capture chamber is configured to receive a gas; the chamber includes one or more carbon capture material configured to adsorb and/or absorb carbon dioxide from the gas. A temperature control system may be configured to remove water vapor and facilitate the release of carbon dioxide from carbon capture material. Chamber may further include and/or be coupled to a vacuum system operable in first mode and second mode. In a first mode vacuum may eliminate waste gas through a selectively sealable air exhaust and a second mode vacuum that directs carbon dioxide into a carbon dioxide collection chamber for downstream processing including liquefy and/or compress gaseous carbon dioxide. In another aspect, the present disclosure includes a controller configured to monitor carbon dioxide concentrations and water vapor concentrations and to operate the system in different states based on sensor feedback.

In one or more embodiments, the present disclosure relates to a dual mode carbon capture chamber configured to capture carbon dioxide from air and subsequently isolate the captured carbon dioxide for collection. In one or more embodiments, air may be directed through a chamber containing one or more carbon capture structures. The one or more carbon capture structures may include thermally conductive fins, plates, channels, contactors, tubes, baffles, or other support structures carrying, coated with, or otherwise associated with an adsorbent material. During a carbon capture state, carbon dioxide from the air may adsorb to the adsorbent material while non-carbon dioxide gases continue through or remain within the chamber.

In one or more embodiments, after carbon dioxide has been adsorbed by the adsorbent material, the chamber may be sealed and operated in a first vacuum mode. During the first vacuum mode, a vacuum system may remove non-carbon dioxide gas, including nitrogen, oxygen, residual air, water vapor, or combinations thereof, from the chamber while carbon dioxide remains adsorbed by the adsorbent material. In one or more embodiments, before or during the first vacuum mode, a temperature control system may preheat the adsorbent material or the carbon capture structure to desorb water vapor from the adsorbent material at a temperature that is lower than a carbon dioxide release temperature. The first vacuum mode may then remove the desorbed water vapor before carbon dioxide is released for collection.

In one or more embodiments, after non-carbon dioxide gas and/or water vapor has been removed from the chamber, the carbon capture structure may be further heated to release carbon dioxide from the adsorbent material. The vacuum system may then operate in a second vacuum mode to remove the released carbon dioxide from the chamber. In one or more embodiments, the second vacuum mode may correspond to a stronger vacuum than the first vacuum mode, a lower absolute pressure than the first vacuum mode, a greater magnitude of negative gauge pressure than the first vacuum mode, a greater pressure differential relative to ambient pressure than the first vacuum mode, or any combination thereof. In one or more embodiments, the vacuum system may include two separate pumps for the first and second vacuum modes. In other embodiments, the vacuum system may include a single pump configured to operate at different pumping powers, speeds, pressures, valve configurations, or operating modes corresponding to the first vacuum mode and the second vacuum mode. In one or more embodiments, at least a portion of a flow path used to remove carbon dioxide during the second vacuum mode may be hermetically sealed to reduce contamination of a carbon dioxide product stream. For the purposes of this disclosure, “hermetically sealed” means sealed, or configured to reduce or prevent leakage of gas into or out of a component. In one or more embodiments, a hermetically sealed extraction pump, carbon dioxide outlet, carbon dioxide outlet valve, conduit, or collection pathway may reduce entry of nitrogen, oxygen, ambient air, water vapor, or other contaminants into carbon dioxide removed during the second vacuum mode.

In one or more embodiments, after carbon dioxide has been removed during the second vacuum mode, the carbon capture structure may be cooled before the chamber returns to the carbon capture state. In one or more embodiments, a temperature control system may circulate cooled fluid, such as cold water, chilled water, glycol, refrigerant, cooled gas, or another heat-transfer fluid, through one or more pipes, tubes, conduits, or channels thermally coupled to the carbon capture structure. Cooling the carbon capture structure may prepare the adsorbent material to adsorb additional carbon dioxide during a subsequent carbon capture cycle. In one or more embodiments, after cooling, the chamber may be repressurized, unsealed, reopened, or otherwise placed in fluid communication with incoming airflow.

In one or more embodiments, a plurality of dual mode carbon capture chambers may be operated together as part of a carbon capture system. The plurality of chambers may be operated asynchronously, such that at least one chamber operates in a carbon capture state while another chamber operates in a first vacuum mode, a second vacuum mode, a cooling state, a repressurization state, a maintenance state, a repair state, or a replacement state. In one or more embodiments, asynchronous operation may allow substantially continuous airflow through at least a portion of the carbon capture system even while individual chambers are sealed for waste gas elimination or carbon dioxide collection.

In one or more embodiments, the carbon capture system may be integrated into an active airflow environment. For example, the carbon capture system may be positioned in, coupled to, or otherwise integrated with a data center airflow path, server cooling airflow path, building ventilation system, heating, ventilation, and air conditioning system, apartment ventilation system, office ventilation system, industrial airflow path, or other environment in which air is moved for a purpose other than carbon capture. In one or more embodiments, such integration may allow the carbon capture system to use existing airflow infrastructure, fans, ducts, filters, or waste heat. In one or more embodiments, waste heat from servers, computing equipment, HVAC equipment, industrial equipment, or another heat source may be used to heat the carbon capture structure, desorb water vapor, release carbon dioxide, reduce energy consumption, or any combination thereof.

In one or more embodiments, carbon dioxide removed during the second vacuum mode may be further processed by a carbon dioxide collection system. In one or more embodiments, the carbon dioxide collection system may remove residual water vapor from the carbon dioxide, cool the carbon dioxide, liquefy the carbon dioxide, compress the carbon dioxide, direct the carbon dioxide to one or more pressurized tanks, direct the carbon dioxide to one or more collection tanks, or any combination thereof. In one or more embodiments, removal of water vapor during the first vacuum mode, together with downstream removal of residual water vapor, may increase purity of the collected carbon dioxide and reduce contamination by nitrogen, oxygen, water vapor, or other non-carbon dioxide gas.

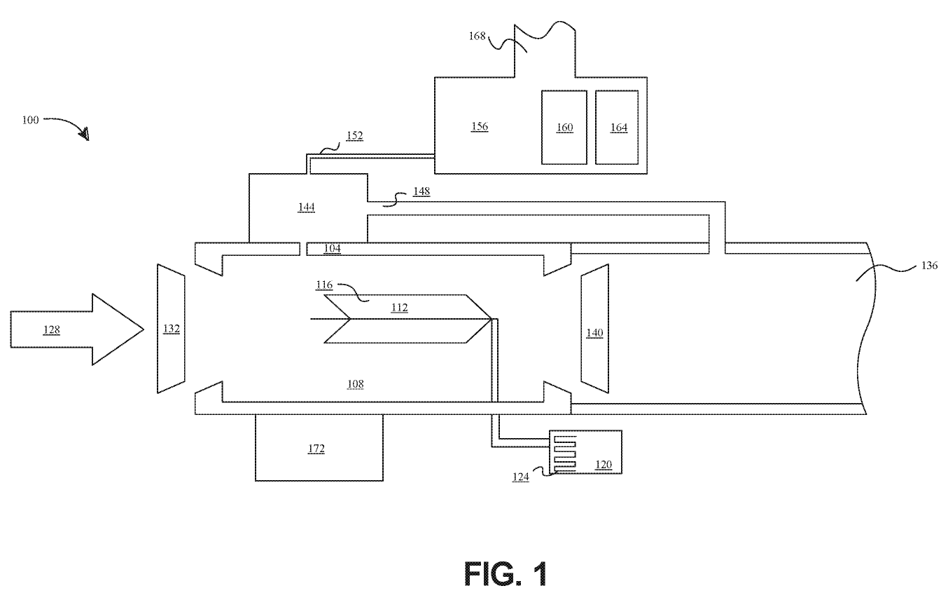

Referring now to FIG. 1, an exemplary embodiment of dual mode carbon capture chamber 100 is illustrated. Dual-mode carbon capture chamber may use external energy to actively capture CO₂ and remove CO₂ from the air. In one or more embodiments, a carbon capture system may include passive solutions, such as biochar, for CO₂ sequestration. Active carbon capture systems may actively flow air to an adsorbent material and actively remove carbon from the surrounding air. In one or more embodiments, an active carbon capture system may use fans and/or already existing infrastructure to divert flowing air to a chamber 100, wherein CO₂ may be actively removed from the surrounding air. In one or more embodiments, an active carbon capture system may rely on chemical adsorption or direct air capture using fans and sorbents. In one or more embodiments, an active carbon capture system may rely on external forces to direct air through the carbon capture system and forcibly remove carbon from the surrounding air. Chamber 100 may be incorporated in and/or otherwise combined with a carbon capture system as disclosed in U.S. Nonprovisional Application No. 19/204,954, filed on May 12, 2025, with attorney docket number 1706-001USU1 and entitled “CARBON CAPTURE SYSTEMS AND METHODS OF USE,” the entirety of which is incorporated herein by reference.

With continued reference to FIG. 1, chamber 100 is configured with at least an exterior wall 104 that is used to provide a structure to chamber 100. For the purposes of this disclosure, an “exterior wall” is a structural boundary or other physical barrier that defines at least a portion of a chamber and separates an interior of the chamber 100 from an external environment. In one or more embodiments, exterior wall 104 may define interior 108 of chamber 100 and may be configured to maintain a sealed environment within chamber 100. In one or more embodiments, exterior wall 104 may be configured to withstand a vacuum pressure within chamber 100. In one or more embodiments, exterior wall 104 may be formed from metal, plastic, composite, polymeric, ceramic, flexible, rigid, thermally conductive, chemically resistant, or structurally reinforced materials, or any combination thereof. In one or more embodiments, at least an exterior wall 104 may ensure that chamber 100 can provide a sealed environment from the atmosphere. In one or more embodiments, at least an exterior wall 104 may provide structural rigidity such that chamber 100 does not collapse or buckle under negative pressure conditions. In one or more embodiments, chamber 100 may be similar in form to a container, wherein at least an exterior wall 104 defines the structure boundary of the container. In one or more embodiments, at least an exterior wall 104 may be made of thermally conductive materials to facilitate a heat transfer between an inside of chamber 100 and an outside of chamber 100. An interior 108 of the chamber 100 is defined by the structure and spatial arrangement of the exterior walls 104 configuration.

With continued reference to FIG. 1, at least an exterior wall of chamber 100 may be formed from various materials selected to provide structural integrity, thermal performance, or chemical resistance. In one or more embodiments, at least an exterior wall may be made of metal materials, including but not limited to stainless steel or aluminum. In one or more embodiments, the plastic materials may be made of flexible plastic materials, including but not limited to high-density polyethylene (HDPE), low-density polyethylene (LDPE), linear low-density polyethylene (LLDPE), polypropylene (PP), or a combination of HDPE and LLDPE.

With continued reference to FIG. 1, chamber 100 may be configured in different shapes along its longitudinal and transverse axes. In one or more embodiments, the chamber may have a uniform cross-sectional shape along the longitudinal axes. In one or more embodiments, the chamber may have a uniform cross-sectional shape along the transverse axes. In one or more embodiments, chamber 100 may have a varied transverse and/or longitudinal cross section, shaped along its longitudinal or transverse axes, respectively. In one or more embodiments, chamber 100 may be made of any combination of curved and/or polygonal geometry. The cross-sectional profile of the chamber may include substantially rectangular forms corresponding to a substantially rectangular prism structure and/or substantially circular or elliptical forms corresponding to substantially cylindrical or lozenge-like structures.

With continued reference to FIG. 1, chamber 100 includes one or more carbon capture structure 112. For the purposes of this disclosure, a “carbon capture structure” is a structure configured to support, retain, carry, or otherwise include an adsorbent material for adsorbing carbon dioxide from air received in a chamber. For the purposes of this disclosure, “carbon dioxide” or “CO₂” is a carbon-containing gaseous compound having the chemical formula CO₂. In one or more embodiments, carbon dioxide may be present in air received in chamber 100 and may be adsorbed by adsorbent material of carbon capture structure 112 during a carbon capture state. In one or more embodiments, carbon dioxide may be released from the adsorbent material when carbon capture structure 112 is heated by temperature control system 120. In one or more embodiments, released carbon dioxide may be removed from interior 108 of chamber 100 during a second vacuum mode and directed through carbon dioxide outlet 152 to carbon dioxide collection system 156.

With continued reference to FIG. 1, in one or more embodiments, carbon capture structure 112 may include an adsorbent material configured to adsorb carbon dioxide from air received in chamber 100. For the purposes of this disclosure, an “adsorbent material” is a material configured to trap molecules on a surface of the material. In one or more embodiments, one or more carbon capture structure 112 may capture or trap molecules through a process called adsorption. “Adsorption” or the process of “adsorbing,” for the purpose of this disclosures, is a process in which molecules, ions or atoms stick to a surface of another molecule through weak Van der Waals forces and/or chemical bonds. In one or more embodiments, during adsorption, molecules from a gas or liquid may encounter an adsorbent surface, such as one or more carbon capture structure 112. In one or more embodiments, molecules may adhere to the surface of a material without penetrating it. In one or more embodiments, adsorption may be contrasted with absorption, wherein absorption includes a process in which molecules penetrate the material. In one or more embodiments, one or more adsorbent material may include materials capable of trapping and holding molecules on the surface of the adsorbent material. In one or more embodiments, one or more adsorbent material may include but are not limited to Zeolites, activated carbon, Chitosan, Amine-functionalized sorbents, Silica gel, porous silicates, Metal-Organic Frameworks, amine-based sorbets, metal oxides, lithium silicates, Sodium zirconates, and/or the like. In one or more embodiments, one or more adsorbent material may contain chemical properties that allow for CO₂ to adhere to a surface of one or more carbon capture structure 112. In one or more embodiments, one or more carbon capture structure 112 may contain chemical properties that allow for CO₂ to be separated from gas through a process of adsorption. In one or more embodiments, one or more adsorbent material may contain amines that chemically bond with CO₂. In one or more embodiments, one or more adsorbent material may contain molecular-sized pores that trap CO₂. In one or more embodiments, one or more carbon capture structure 112 may adsorb CO₂ through physical adsorption. In one or more embodiments, physical adsorption or “physisorption” includes a process in one or more carbon capture structures 112 that rely on high surface area and porous structures to trap CO₂. In one or more embodiments, one or more carbon capture structure 112 may contain a microporous structure that is used to capture CO₂. In one or more embodiments, physisorption may contain weak van der Waals forces between CO₂ and one or more carbon capture structure 112 in order to allow for the reuse of one or more carbon capture structure 112. In one or more embodiments, weak forces may allow for a system to trap CO₂ using one or more carbon capture structure 112 and remove the CO₂ from the one or more carbon capture structure 112 when desired. In one or more embodiments, one or more carbon capture structure 112 may capture or trap molecules through a process called absorption. The purpose of this disclosure refers to a process in which carbon dioxide is removed from a gas mixture by dissolving into an absorbent material that selectively interacts with carbon dioxide. In one or more embodiments, one or more absorbent material may be a liquid solvent that has contact with gas in the chamber 100. In one or more embodiments, one or more absorbent material may include but are not limited to physical solvents, amines (e.g., monoethanolamine, diethanolamine), potassium carbonate solutions, ionic liquids, nanofluid, and/or the like. In one or more embodiments, one or more absorbent material may contain chemical properties that allow for a chemical reaction between carbon dioxide and the solvent, such as acid-base or nucleophilic mechanisms. In one or more embodiments, one or more carbon capture structure 112 may contain chemical properties that allow for CO₂ to be separated from gas through a process of absorption. In one or more embodiments, one or more carbon capture structure 112 may contain physical properties that allow carbon dioxide to bound by weak van der Waal forces in the solvent and allow for separation of carbon dioxide from air. In one or more embodiments, one or more carbon capture structure 112 may operate under a principle consistent with Henry’s law, which increases efficiency at partial pressure and low temperature.

With continued reference to FIG. 1, one or more carbon capture structure 112 may include a material body with an adsorbent coating. In one or more embodiments, a material body may provide structure for one or more carbon capture structure 112. In one or more embodiments, a material body may include materials such as stainless steel, aluminum alloys, ceramic materials, such as silicon carbide and/or alumina, Polymeric materials such as polyamides and polysulfides, and/or the like. In one or more embodiments, an adsorbent coating and/or adsorbent material may provide the adsorbent properties for one or more carbon capture structure 112. In one or more embodiments, an adsorbent coating may cover a surface of a material body. In one or more embodiments, an adsorbent coating may include Zeolites, activated carbon, amines, and/or other materials as described above.

Still referring to FIG. 1, in one or more embodiments, the carbon capture structure may include a material body, at least a fin 116, a plurality of fins, one or more tubes, one or more sheets, one or more porous bodies, an adsorbent coating, or any combination thereof. In one or more embodiments, the carbon capture structure may include an adsorbent material disposed on a thermally conductive support, such that the adsorbent material adsorbs carbon dioxide from air received in chamber 100 and the thermally conductive support transfers heat to release the adsorbed carbon dioxide. As a non-limiting example, an element of one or more carbon capture structure 112 may have a shape, such as, for example, a planar sheet, a cylindrical tube, and/or the like. In one or more embodiments, the shape of one or more carbon capture structure 112 may include at least a fin 116. For the purposes of this disclosure, a “fin” is a flattened projection from a body. In some cases, fin 116 may act to maximize surface area for the purposes of adsorption, absorption, heat exchange, or the like. In one or more embodiments, at least a fin 116 may include but not limited to straight fins, annular fins, radial fins, pin fins. In one or more embodiments, at least a fin 116 may include copper and stainless, brazing techniques and surface treatments that are employed to improve durability and thermal efficiency. In one or more embodiments, at least a fin 116 may provide structural support within chamber 100 that can endure mechanical and thermal stresses under vacuum conditions. In one or more embodiments, at least a fin 116 may be positioned, dimensioned, or otherwise configured to provide structural support to exterior wall 104 under vacuum pressure. For example, at least a fin 116 may contact or extend between portions of exterior wall 104 to resist inward deformation, collapse, or buckling of exterior wall 104 when vacuum system 144 generates a vacuum pressure within chamber 100.

With continued reference to FIG. 1, in one or more embodiments, one or more carbon capture structure 112 may be made of thermally conductive materials disposed within the chamber 100. For the purposes of this disclosure, a “thermally conductive material” is a material configured to conduct or convey heat from one portion of the material to another portion of the material, or from one component to another component thermally coupled thereto. In one or more embodiments, the thermally conductive materials may be at least a fin. In one or more embodiments, thermally conductive material may contain physical properties capable of heat transfer. For example, and without limitation, thermally conductive material may include metals with high heat transfer coefficients in order to modify a temperature of one or more carbon capture structure 112. Thermally conductive material is said to have “thermally conductive properties” as described in this disclosure if it contains the ability to conduct heat. In one or more embodiments, at least a fin 116 made of thermally conductive material may include a thermal conductivity of 10 (W/m·K) or greater. In one or more embodiments, thermal conductive properties may include aluminum, copper, stainless steel, silver, graphite, metals, and/or the like. In one or more embodiments, thermally conductive material is covered by one or more adsorbent material configured to adsorb carbon dioxide within a low temperature range. The adsorbent material may be capable of capturing carbon dioxide at temperatures ranging from approximately 5°C to 14°C.

With continued reference to FIG. 1, in one or more embodiments, one or more carbon capture structure 112 may capture or trap molecules through a process called “electrochemical carbon capture.” “Electrochemical carbon capture,” for the purpose of this disclosure, is a process that uses electron transfer reaction to drive carbon dioxide separation for gas. In one or more embodiments, electrochemical carbon capture may include an electrochemical cell configured to generate acid/base pairs to control pH in solution, wherein at a relatively high pH carbon dioxide may be captured as bicarbonate or carbonate, and at a relatively low pH, carbon dioxide may be released as a gas. In one or more embodiments, electrochemical carbon capture may include applying a voltage between two electrodes (anode and cathode) in an electrochemical cell that drives redox reactions, wherein the reaction may either consume or generate protons (H⁺) or hydroxide ions (OH⁻) which can modify the local pH of the system. In one or more embodiments, a basic environment in electrochemical carbon capture system may be used for carbon dioxide capture and an acidic environment may be used for carbon dioxide release. In one or more embodiments, voltage generated from the electrochemical carbon capture may adjust pH through electron flow. In one or more embodiments, adjusting pH in one or more carbon capture material may include chemical adjustment by adding chemicals like addition of acids and bases to drive carbon dioxide capture. In one or more embodiments, electrochemical carbon capture may include electrochemically mediated amine regeneration, wherein amines may form carbamates with carbon dioxide in solution and a metal ion (e.g., Cu²⁺) may be electrochemically generated to displace carbon dioxide from the amine and allow regeneration without thermal input. In one or more embodiments, electrochemical carbon capture may include an electrochemical cell with an ion-exchange or bipolar membrane configured to separate acidic and basic regions, wherein carbon dioxide may be adsorbed and transported across the membrane via charged carbonate/bicarbonate species and may be released through local pH changes. In one or more embodiments, electrochemical carbon capture may include a faradaic electroswing adsorption process, wherein solid sorbents coated with redox-active functional groups may adsorb carbon dioxide under one electric potential and release it under another.

With continued reference to FIG. 1, chamber 100 includes a temperature control system 120. For the purposes of this disclosure, a “temperature control system” is a system configured to control a temperature of one or more components, materials, fluids, gases, or regions. In one or more embodiments, a temperature control system may be thermally coupled to carbon capture structure 112 and may be configured to heat carbon capture structure 112 to release carbon dioxide adsorbed by an adsorbent material. In one or more embodiments, a temperature control system may include a heater, cooler, heat exchanger, heat pump, fluid circuit, conduit, tube, valve, temperature sensor, controller, thermal source, thermal sink, or any combination thereof. In one or more embodiments, a temperature control system may be configured to circulate a heated fluid to heat carbon capture structure 112 and/or circulate a cooled fluid to cool carbon capture structure 112 after carbon dioxide is removed from chamber 100.

With continued reference to FIG. 1, in one or more embodiments, a temperature control system 120 may include a thermal source responsible for regulating a temperature within chamber 100. A “thermal source,” as used in this disclosure, is a component that provides or removes heat energy, acting to heat or cool other elements of a system. In one or more embodiments, thermal source may include a heating element, such as an electric resistance heater, and/or a cooling element, such as a thermoelectric cooler or a compressive cooler. In one or more embodiments, temperature control system 120 may include a plurality of thermal sources, such as a first thermal source including a first type of heating and/or cooling element and a second thermal source including a second type of heating and/or cooling element. In one or more embodiments, a second thermal source may be included to supplement heat when a first thermal source is insufficient to maintain a desired temperature. A first and/or second thermal source may include at least a heating element, such as an electric resistance heater, and/or a cooling element, such as a thermoelectric cooler or a compressive cooler. In one or more embodiments, temperature control system 120 may include an automatic temperature control system 120 wherein both a first thermal source and a second thermal source are used. Temperature control system 120 may be configured to have a first mode temperature for carbonic substance (e.g., carbon dioxide) capture on one or more carbon capture structure 112. For the purposes of this disclosure, a “first mode temperature” is a temperature or range of temperatures at which adsorbent material of a carbon capture structure is configured to adsorb carbon dioxide from air received in a chamber. In one or more embodiments, the first mode temperature may be a carbon capture temperature, adsorption temperature, cooling temperature, chamber temperature, surface temperature of carbon capture structure 112, surface temperature of at least a fin 116, temperature of the adsorbent material, or any combination thereof. In one or more embodiments, the first mode temperature may be lower than a second mode temperature. In one or more embodiments, first mode temperature may range from approximately 5℃ to 35℃.

With continued reference to FIG. 1, temperature control system 120 may be configured to have a second mode temperature for carbon dioxide release. For the purposes of this disclosure, a “second mode temperature” is a temperature or range of temperatures at which carbon dioxide adsorbed by adsorbent material of a carbon capture structure is released or removed from the adsorbent material. In one or more embodiments, the second mode temperature may be a carbon release temperature, desorption temperature, heating temperature, chamber temperature, surface temperature of carbon capture structure 112, surface temperature of at least a fin 116, temperature of the adsorbent material, or any combination thereof. In one or more embodiments, the second mode temperature may be higher than the first mode temperature. In one or more embodiments, second mode temperature may range from approximately 85℃ to 258℃.

With continued reference to FIG. 1, in one or more embodiments, the temperature control system 120 may include a heat exchanger 124. A “heat exchanger” for the purpose of this disclosure is a system configured to transfer heat from between a heat source and/or sink and a fluid. For example, without limitation, a heat exchanger 124 may include a device that transfers heat from a hot liquid, such as water to air and CO₂ captured in the chamber. In one or more embodiments, a fluid may absorb heat from heat exchanger 124 and thereby cause the fluid to be heated. In one or more embodiments, a heat exchanger 124 may include a solid barrier, wherein a heated fluid may transfer heat to a solid barrier, and non-heated fluid may receive the heat from the solid barrier. In one or more embodiments, a heat exchanger 124 may contact a surface of one or more carbon capture structure 112 and/or at least a fin 116, wherein a heated fluid may contact a surface of one or more carbon capture structure 112 and transfer heat to one or more carbon capture structure 112. In one or more embodiments, a heat exchanger 124 may heat gas in a chamber by applying heat to one or more carbon capture structure 112. In one or more embodiments, one or more carbon capture structure 112 may have a higher thermal conductivity, wherein one or more carbon capture structure 112 may be capable of conducting heat. In one or more embodiments, in a heat exchanger 124, heat moves through a solid barrier, such as through or around tubular piping, wherein the heat exchanger 124 may transfer heat onto one or more carbon capture structure 112. In one or more embodiments, air captured in a chamber may travel through an inner surface of one or more carbon capture structure 112, wherein a heat exchanger 124 may contact an outer surface of one or more carbon capture structure 112 and apply heat to one or more carbon capture structure 112. In one or more embodiments, a heat exchanger 124 may include a heat pump configured to heat a fluid. In one or more embodiments, a heat pump may facilitate movement of a heated fluid through piping and/or channels. In one or more embodiments, piping and/or channels may contact one or more carbon capture structure 112. In one or more embodiments, a heat exchanger 124 may engage in a temperature swing adsorption (TSA) process wherein heat applied to one or more carbon capture structure 112 may cause CO2 to detach from the one or more carbon capture structure 112. In one or more embodiments, a heat exchanger 124 may contact at least a fin 116 within chamber 100, and the heat exchanger 124 may apply heat to at least a fin 116 and thereby apply heat to chamber 100. In one or more embodiments, heated fluid may be iteratively recirculated through a heat pump to apply additional heat to heated fluid wherein heated fluid may transfer heat to chamber 100. In one or more embodiments, heat exchanger 124 may provide heat through a conduction and/or convection process. In one or more embodiments, a conduction process may be a process by which heat transfers through a solid material from a hotter region to a cooler region without the movement of the material itself. For example, and without limitation, a heat exchanger 124 may transfer heat through one or more carbon capture structure 112 and/or a material separating heat exchanger 124 and one or more carbon capture structure 112. In one or more embodiments, a heated fluid may heat a thermally conductive material wherein the heat may be transferred to one or more carbon capture structure 112. In one or more embodiments, in shell-and-tube or plate heat exchangers 124, hot and cold fluids may be separated by a solid metal barrier. In one or more embodiments, in thermal swing adsorption (TSA), heat exchange may warm up one or more carbon capture structure 112, for example, but not limited to zeolite, MOFs, and amines, to release captured CO₂. In one or more embodiments, heat exchanger 124 may be configured to provide a first mode temperature to the chamber 100 on the one or more carbon capture structure 112 during carbon capture and a second mode temperature during carbonic substance releases. In one or more embodiments, first mode temperature may range from approximately 5℃ to 35℃, and second mode temperature may range from approximately 85℃ to 258℃.

With continued reference to FIG. 1, in one or more embodiments, the heat exchanger 124 may include one or more tubes thermally coupled to the carbon capture structure. For the purposes of this disclosure, “tubes” are channeled structures configured to convey a fluid. In one or more embodiments, the one or more tubes may be thermally coupled to carbon capture structure 112 and may be configured to receive a heated fluid to heat carbon capture structure 112 and/or receive a cooled fluid to cool carbon capture structure 112. In one or more embodiments, the one or more tubes may include pipes, conduits, channels, coils, manifolds, capillaries, passages, fluid lines, or any combination thereof. In one or more embodiments, the one or more tubes may be formed from a thermally conductive material, including aluminum, copper, stainless steel, silver, graphite, metals, alloys, ceramics, composites, or any combination thereof. For the purposes of this disclosure, “thermally coupled” means configured such that heat may be transferred between two or more components. In one or more embodiments, one or more tubes may be thermally coupled to carbon capture structure 112 by direct contact, indirect contact through an intermediate thermally conductive material, attachment to at least a fin 116, embedding within carbon capture structure 112, brazing, welding, bonding, fastening, clamping, press-fitting, adhesive coupling, or any combination thereof. In one or more embodiments, thermally coupled components may transfer heat by conduction, convection, radiation, or any combination thereof.

With continued reference to FIG. 1, the one or more tubes may be configured to receive a heated fluid, such as heated water, to heat the carbon capture structure and release carbon dioxide from the adsorbent material. The one or more tubes may also be configured to receive a cooled fluid, such as cooled water, to cool the carbon capture structure after carbon dioxide is removed from chamber 100 during the second vacuum mode. Cooling the carbon capture structure may prepare the adsorbent material for a subsequent carbon capture state. For the purposes of this disclosure, a “heated fluid” is a fluid having a temperature sufficient to transfer heat to one or more components thermally coupled thereto. In one or more embodiments, the heated fluid may be received by one or more tubes thermally coupled to carbon capture structure 112 and may transfer heat to carbon capture structure 112 to release carbon dioxide from an adsorbent material. In one or more embodiments, the heated fluid may include heated water, steam, thermal oil, glycol, refrigerant, gas, air, or any other liquid, vapor, gas, or heat-transfer fluid. In one or more embodiments, the heated fluid may be circulated through one or more tubes, conduits, channels, coils, manifolds, passages, or fluid lines. For the purposes of this disclosure, a “cooled fluid” is a fluid having a temperature sufficient to remove heat from one or more components thermally coupled thereto. In one or more embodiments, the cooled fluid may be received by one or more tubes thermally coupled to carbon capture structure 112 and may remove heat from carbon capture structure 112 after carbon dioxide is removed from chamber 100. In one or more embodiments, the cooled fluid may include cooled water, chilled water, glycol, refrigerant, gas, air, or any other liquid, vapor, gas, or heat-transfer fluid. In one or more embodiments, the cooled fluid may be circulated through one or more tubes, conduits, channels, coils, manifolds, passages, or fluid lines.

With continued reference to FIG. 1, chamber 100 may include a selectively sealable air intake 128. For the purposes of this disclosure, a “selectively sealable air intake” is an inlet or other structure configured to selectively permit or prevent air from entering a chamber. In one or more embodiments, selectively sealable air intake 128 may be opened during a carbon capture state to permit air to enter chamber 100 and may be closed or sealed during a first vacuum mode, a second vacuum mode, a waste gas elimination state, a carbon collection state, or a combination thereof. In one or more embodiments, selectively sealable air intake 128 may include an intake valve, gate valve, check valve, solenoid valve, motor-actuated valve, damper, flap, lid, cap, gasket, elastomeric seal, fan, duct, filter, grille, mesh, conduit, or any combination thereof.

With continued reference to FIG. 1, selectively sealable air intake 128 may be configured to receive gas such as without limitation air into chamber 100. In one or more embodiments, a selectively sealable air intake 128 may include a turbine, or other device functioning as an impeller, configured to cause air to flow into chamber 100. In one or more embodiments, a selectively sealable air intake 128 may include a fan and/or any other devices configured to provide for air to flow into chamber 100. In one or more embodiments, a selectively sealable air intake 128 may include air intake ducts. In one or more embodiments, a selectively sealable air intake 128 may include large ducts or openings designed to pull in ambient air. In one or more embodiments, a selectively sealable air intake 128 may include protective covers, such as grilles and/or mesh in order to prevent and/or minimize debris from entering chamber 100. In one or more embodiments, a selectively sealable air intake 128 may include filters that only allow air to enter chamber 100 while removing dust, particulates, and/or objects. In one or more embodiments, a selectively sealable air intake 128 may include filters and/or fans to ensure a steady flow of air into chamber 100.

With continued reference to FIG. 1, in one or more embodiments, a selectively sealable air intake 128 may include intake valve 132 in order to regulate the volume of air entering chamber 100. For the purposes of this disclosure, an “intake valve” is a flow-control component configured to regulate air from entering a chamber through a selectively sealable air intake. In one or more embodiments, intake valve 132 may be movable between an open position, a closed position, and/or one or more partially open positions. In one or more embodiments, intake valve 132 may be opened during a carbon capture state to permit air to enter chamber 100 and may be closed or sealed during a first vacuum mode, a second vacuum mode, a waste gas elimination state, a carbon collection state, or any combination thereof. In one or more embodiments, intake valve 132 may include a solenoid valve, motor-actuated valve, sliding gate valve, check valve, butterfly valve, ball valve, flap valve, damper, hinged lid, threaded cap, elastomeric seal, gasket, or any combination thereof. In one or more embodiments, a selectively sealable air intake 128 may be configured to prevent external air from entering when the intake valve 132 is in a closed position. In one or more embodiments, a sealing mechanism, such as a hinged lid or a threaded cap, may be coupled with the intake valve 132 to form an airtight seal when closed. In one or more embodiments, the intake valve 132 is sealable via a sliding gate valve that includes an elastomeric seal.

With continued reference to FIG. 1, in one or more embodiments, an intake valve 132 may be used to control the direction of gas. In one or more embodiments, air may flow into one or more portions of chamber 100. In one or more embodiments, the intake valve 132 may include motors and/or solenoid valves that are configured to control a flow of air into chamber 100. In one or more embodiments, intake valve 132 may be controlled using a controller 172 as described in further detail below.

With continued reference to FIG. 1, a selectively sealable air exhaust 136 may be configured to remove unwanted gas, such as air that has already passed over and/or through carbon capture components. An “air exhaust” for the purpose of this disclosure refers to a device or a component that facilitates the removal of unwanted air. In some cases, air exhaust may include a shaft or opening through which air from which carbon dioxide has been captured can escape. For example, and without limitation, an air conditioning unit may contain an exhaust system that removes heated air that was initially used to cool down components of the air conditioning unit. For the purposes of this disclosure, a “selectively sealable air exhaust” is an outlet or other structure configured to selectively permit or prevent gas from exiting a chamber. In one or more embodiments, selectively sealable air exhaust 136 may be opened during a carbon capture state to permit airflow through chamber 100 and may be closed or sealed during a first vacuum mode, a second vacuum mode, a waste gas elimination state, a carbon collection state, or a combination thereof.

With continued reference to FIG. 1, in one or more embodiments, selectively sealable air exhaust 136 may include an exhaust valve, outlet valve, gate valve, check valve, solenoid valve, motor-actuated valve, damper, flap, lid, cap, gasket, elastomeric seal, fan, duct, filter, grille, mesh, conduit, or any combination thereof. For the purposes of this disclosure, an “exhaust valve” is a flow-control component configured to regulate gas from exiting a chamber through a selectively sealable air exhaust. In one or more embodiments, exhaust valve 140 may be movable between an open position, a closed position, and/or one or more partially open positions. In one or more embodiments, exhaust valve 140 may be opened during a carbon capture state to permit gas to exit chamber 100 and may be closed or sealed during a first vacuum mode, a second vacuum mode, a waste gas elimination state, a carbon collection state, or any combination thereof. In one or more embodiments, exhaust valve 140 may include a solenoid valve, motor-actuated valve, sliding gate valve, check valve, butterfly valve, ball valve, flap valve, damper, hinged lid, threaded cap, elastomeric seal, gasket, or any combination thereof.

With continued reference to FIG. 1, in one or more embodiments, a selectively sealable air exhaust 136 may include a fan configured to remove unwanted air or gases from within an enclosed space. In one or more embodiments, a selectively sealable air exhaust 136 may include a duct that allows for unwanted air or gases to be removed from a particular system. In one or more embodiments, a selectively sealable air exhaust 136 includes outlet valve 140 in order to regulate the volume of air in existing chamber 100. In one or more embodiments, a selectively sealable air exhaust 136 may be configured to prevent internal air from exiting when the outlet valve 140 is in a closed position. In one or more embodiments, a sealing mechanism, such as a hinged lid or a threaded cap, may be coupled with the outlet valve 140 to form an airtight seal when closed. In one or more embodiments, the outlet valve 140 may be sealable via a sliding gate valve that includes an elastomeric seal. In one or more embodiments, an outlet valve 140 may include motors and/or solenoid valves that are configured to control a flow of air exiting chamber 100. In one or more embodiments, outlet valves may be controlled using a controller 172 as described in further detail below.

With continued reference to FIG. 1, as used in this disclosure, a “valve” is a component that controls fluidic communication between two or more components. Exemplary non-limiting valves include directional valves, control valves, selector valves, multi-port valves, check valves, and the like. Valves may include any suitable valve construction, including ball valves, butterfly valves, needle valves, globe valves, gate valves, wafer valves, regulator valves, and the like. Valves may be included in a manifold of hydraulic or pneumatic circuits, for example, allowing for multiple ports and flow paths. Valves may be actuated by any known method, such as, without limitation, by way of hydraulic, pneumatic, mechanical, or electrical energy. For instance, in some cases, a valve may be actuated by an energized solenoid or electric motor. Valve actuators and thereby valves themselves may be controlled by a computing device and/or controller 172.

With continued reference to FIG. 1, the chamber 100 further a vacuum system 144 in fluid communication with chamber 100. For the purposes of this disclosure, a “vacuum system” is a system configured to extract gases, substances, and/or molecules from a chamber or space. In one or more embodiments, vacuum system 144 may include one or more vacuum pumps. For the purposes of this disclosure, a “vacuum pump” is a device configured to remove gas, vapor, fluid, molecules, or a combination thereof from an enclosed volume to reduce a pressure within the enclosed volume. In one or more embodiments, a vacuum pump may be included in a vacuum system and may be configured to evacuate at least a portion of chamber 100. In one or more embodiments, a vacuum pump may be configured to operate at one or more vacuum power levels, vacuum pressures, flow rates, pumping speeds, or operating modes. In one or more embodiments, a vacuum pump may include, without limitation, a rotary vane pump, diaphragm pump, scroll pump, liquid ring pump, roots pump, claw pump, screw pump, turbomolecular pump, diffusion pump, cryopump, sputter ion pump, or any combination thereof.

With continued reference to FIG. 1, in one or more embodiments, vacuum system 144 may include a vacuum pump having an input port directly connected to interior 108 of chamber 100. In one or more embodiments, vacuum system 144 may include a waste gas outlet 148 and a carbon dioxide outlet 152. For the purposes of this disclosure, a “waste gas outlet” is a structure configured to direct non-carbon dioxide gas, water vapor, or a combination thereof out of a chamber during a specified or first vacuum mode. In one or more embodiments, waste gas outlet 148 may be fluidly coupled to vacuum system 144 and may be configured to output non-carbon dioxide gas removed from interior 108 of chamber 100 while carbon dioxide remains adsorbed by an adsorbent material of carbon capture structure 112. For the purposes of this disclosure, a “non-carbon dioxide gas” is a gas, vapor, or gaseous mixture other than carbon dioxide that may be present within a chamber. In one or more embodiments, non-carbon dioxide gas may include nitrogen, oxygen, argon, air, residual atmospheric gas, water vapor, volatile compounds, or any combination thereof. In one or more embodiments, non-carbon dioxide gas may be removed from interior 108 of chamber 100 during a first vacuum mode while carbon dioxide remains adsorbed by adsorbent material of carbon capture structure 112. In one or more embodiments, non-carbon dioxide gas may be directed out of chamber 100 through waste gas outlet 148.

In one or more embodiments, waste gas outlet 148 may include a waste gas outlet valve, check valve, solenoid valve, motor-actuated valve, pressure-regulating valve, duct, vent, manifold, conduit, gas line, filter, or any combination thereof. For the purposes of this disclosure, a “waste gas outlet valve” is a flow-control component configured to regulate flow of non-carbon dioxide gas, water vapor, or a combination thereof through a waste gas outlet. In one or more embodiments, waste gas outlet valve may be opened during a first vacuum mode to permit non-carbon dioxide gas to exit chamber 100 through waste gas outlet 148 and may be closed during a second vacuum mode to prevent carbon dioxide released from adsorbent material of carbon capture structure 112 from exiting through waste gas outlet 148. In one or more embodiments, waste gas outlet valve may include a solenoid valve, motor-actuated valve, sliding gate valve, check valve, butterfly valve, ball valve, flap valve, damper, pressure-regulating valve, one-way valve, gasket, elastomeric seal, or any combination thereof.

With continued reference to FIG. 1, for the purposes of this disclosure, a “carbon dioxide outlet” is a structure configured to direct carbon dioxide out of a chamber during a specified second vacuum mode. In one or more embodiments, carbon dioxide outlet 152 may be fluidly coupled to vacuum system 144 and/or carbon dioxide collection system 156 and may be configured to output carbon dioxide released from the adsorbent material of carbon capture structure 112 after carbon capture structure 112 is heated by temperature control system 120. In one or more embodiments, carbon dioxide outlet 152 may include a carbon dioxide outlet valve, check valve, solenoid valve, motor-actuated valve, pressure-regulating valve, duct, vent, manifold, conduit, gas line, sealed transfer line, or any combination thereof. For the purposes of this disclosure, a “carbon dioxide outlet valve” is a flow-control component configured to regulate flow of carbon dioxide through a carbon dioxide outlet. In one or more embodiments, carbon dioxide outlet valve may be opened during a second vacuum mode to direct carbon dioxide released from adsorbent material of carbon capture structure 112 into carbon dioxide collection system 156 and may be closed during a first vacuum mode to prevent non-carbon dioxide gas, water vapor, or a combination thereof from entering carbon dioxide collection system 156 through carbon dioxide outlet 152. In one or more embodiments, carbon dioxide outlet valve may include a solenoid valve, motor-actuated valve, sliding gate valve, check valve, butterfly valve, ball valve, flap valve, damper, pressure-regulating valve, one-way valve, gasket, elastomeric seal, or any combination thereof.

With continued reference to FIG. 1, for the purposes of this disclosure, a “carbon dioxide collection system” is a system configured to receive or process collect carbon dioxide removed from a chamber. In one or more embodiments, carbon dioxide collection system 156 may be fluidly coupled to carbon dioxide outlet 152 and may be configured to receive carbon dioxide released from adsorbent material of carbon capture structure 112 during a second vacuum mode. In one or more embodiments, carbon dioxide collection system 156 may include a heating system configured to remove water vapor from the carbon dioxide, a cooling system configured to liquefy the carbon dioxide, one or more collection tanks, one or more pressurized tanks, one or more compressors, condensers, separators, conduits, valves, sensors, pumps, or any combination thereof. In one or more embodiments, carbon dioxide collection system 156 may be configured to direct collected carbon dioxide into one or more pressurized tanks for storage or further use. For the purposes of this disclosure, a “heating system” is a system configured to apply heat, increase a temperature, and/or remove water vapor from carbon dioxide. In one or more embodiments, heating system 160 may be included in carbon dioxide collection system 156 and may be configured to heat carbon dioxide received from carbon dioxide outlet 152 to remove water vapor from the carbon dioxide before cooling, liquefaction, compression, storage, or any combination thereof. In one or more embodiments, heating system 160 may include a heater, heat exchanger, heat pump, heating element, resistive heater, thermal source, heated conduit, heated chamber, separator, condenser, moisture-removal unit, desiccant unit, membrane separator, valve, sensor, controller, or any combination thereof. For the purposes of this disclosure, a “cooling system” is a system configured to remove heat from, reduce a temperature of, condense, liquefy, or otherwise condition carbon dioxide. In one or more embodiments, cooling system 164 may be included in carbon dioxide collection system 156 and may be configured to liquefy carbon dioxide received from heating system 160 and/or carbon dioxide outlet 152. In one or more embodiments, cooling system 164 may include a refrigeration unit, thermoelectric cooler, cryogenic cooling loop, condenser, compressor, heat exchanger, chilled conduit, cooling chamber, thermal sink, valve, sensor, controller, collection tank, or any combination thereof. For the purposes of this disclosure, an “outlet” is a structure configured to direct, discharge, transfer, or otherwise output a gas, liquid, vapor, or fluid from one component to another component or to an external destination. In one or more embodiments, outlet 168 may be included in carbon dioxide collection system 156 and may be configured to direct carbon dioxide into one or more pressurized tanks. In one or more embodiments, outlet 168 may include a one-way valve, check valve, pressure-regulating valve, sealed conduit, gas transfer line, high-pressure hose, quick-connect fitting, gas-tight seal, manifold, or any combination thereof.

With continued reference to FIG. 1, in one or more embodiments, vacuum system 144 may be configured to operate in a first vacuum mode and a second vacuum mode. For the purposes of this disclosure, a “first vacuum mode” is an operating mode of a vacuum system in which the vacuum system removes non-carbon dioxide gas, water vapor, or a combination thereof from a chamber while carbon dioxide remains adsorbed by an adsorbent material of a carbon capture structure. In one or more embodiments, the first vacuum mode may include operating one or more vacuum pumps at a first vacuum power level, a first vacuum pressure, a first pumping speed, or a first flow rate. In one or more embodiments, during the first vacuum mode, selectively sealable air intake 128 and selectively sealable air exhaust 136 may be sealed, a waste gas outlet may be opened, and a carbon dioxide outlet may be closed. For the purposes of this disclosure, a “vacuum pressure” is a pressure within a chamber that is lower than an ambient pressure or atmospheric pressure surrounding the chamber. In one or more embodiments, vacuum pressure may refer to an absolute pressure within chamber 100, a pressure differential between interior 108 of chamber 100 and an external environment, a negative gauge pressure, or a degree of evacuation produced by vacuum system 144. For the purposes of this disclosure, a “first vacuum pressure” is a vacuum pressure generated within chamber 100 by vacuum system 144 during a first vacuum mode. In one or more embodiments, the first vacuum pressure may be a pressure sufficient to remove non-carbon dioxide gas, water vapor, or a combination thereof from interior 108 of chamber 100 while carbon dioxide remains adsorbed by adsorbent material of carbon capture structure 112. In one or more embodiments, the first vacuum pressure may correspond to a rough vacuum pressure, low vacuum pressure, negative gauge pressure, reduced chamber pressure, first pressure differential relative to ambient pressure, or first degree of evacuation.

With continued reference to FIG. 1, for the purposes of this disclosure, a “second vacuum mode” is an operating mode of a vacuum system in which the vacuum system removes carbon dioxide released from an adsorbent material of a carbon capture structure after the carbon capture structure is heated by a temperature control system. In one or more embodiments, the second vacuum mode may include operating one or more vacuum pumps at a second vacuum power level, a second vacuum pressure, a second pumping speed, or a second flow rate. In one or more embodiments, vacuum system 144 may be configured to generate a first vacuum pressure during a first vacuum mode and a second vacuum pressure during a second vacuum mode. For the purposes of this disclosure, a “second vacuum pressure” is a vacuum pressure generated within chamber 100 by vacuum system 144 during a second vacuum mode. In one or more embodiments, the second vacuum pressure may be a pressure sufficient to remove carbon dioxide released from adsorbent material of carbon capture structure 112 after carbon capture structure 112 is heated by temperature control system 120. In one or more embodiments, the second vacuum pressure may be greater than the first vacuum pressure such that the second vacuum pressure corresponds to a stronger vacuum, lower absolute pressure, greater negative gauge pressure, greater pressure differential relative to ambient pressure, or greater degree of evacuation than the first vacuum pressure. In one or more embodiments, the term “greater than,” when used to compare the second vacuum pressure to the first vacuum pressure, may refer to a greater magnitude of vacuum relative to atmospheric or ambient pressure. For example, the second vacuum pressure may be greater than the first vacuum pressure when the second vacuum pressure has a larger negative gauge-pressure magnitude, a greater pressure differential relative to ambient pressure, and/or a lower absolute pressure than the first vacuum pressure. In this manner, the second vacuum pressure may represent a stronger vacuum than the first vacuum pressure.

With continued reference to FIG. 1, in one or more embodiments, the second vacuum pressure may be greater than the first vacuum pressure such that the second vacuum mode produces a stronger vacuum, a lower absolute pressure, a greater pressure differential relative to ambient pressure, or a greater degree of evacuation than the first vacuum mode. As a non-limiting illustrative example, during the first vacuum mode, vacuum system 144 may generate a first vacuum pressure sufficient to remove non-carbon dioxide gas, such as nitrogen, oxygen, and/or water vapor, from interior 108 of chamber 100 while carbon dioxide remains adsorbed by the adsorbent material. For instance, the first vacuum pressure may correspond to a rough vacuum level. During the second vacuum mode, vacuum system 144 may generate a second vacuum pressure that is greater than the first vacuum pressure, such that the second vacuum pressure provides a stronger vacuum to remove carbon dioxide released from the adsorbent material after carbon capture structure 112 is heated by temperature control system 120. For example, the second vacuum pressure may correspond to a high vacuum level capable of extracting a carbon-dioxide-rich gas from interior 108 of chamber 100 through carbon dioxide outlet 152. In one or more embodiments, during the second vacuum mode, selectively sealable air intake 128 and selectively sealable air exhaust 136 may be sealed, the waste gas outlet may be closed, and the carbon dioxide outlet may be opened.

With continued reference to FIG. 1, in one or more embodiments, vacuum system 144 may include a single vacuum pump configured to toggle between the first vacuum mode and the second vacuum mode. In one or more embodiments, vacuum system 144 may include a first vacuum pump configured to operate in the first vacuum mode and a second vacuum pump configured to operate in the second vacuum mode. In one or more embodiments, the input port may be configured as a vacuum hose or a flange connection. In one or more embodiments, the connection between the vacuum pump and the chamber may form a tight seal to prevent ambient air from entering the chamber during vacuum operation. At least a vacuum system 144 includes a waste gas outlet 148 that releases air to the outside environment and a carbon dioxide outlet 152 in communication with the temperature control system 120 and configured to connect to a carbon dioxide collection system 156. In one or more embodiments, the waste gas outlet 148 may be integrated with a selectively sealable air exhaust 136, such as both components share a common vent or duct through which air is expelled from the chamber 100. In one or more embodiments, the waste gas outlet 148 may be implemented as a separate and independent venting system distinct from a selectively sealable air exhaust. For example, and without limitation, at least a vacuum system 144 may include a first vacuum configured to remove a first substance (e.g., waste gas) from the chamber 100 in a first mode and a second vacuum configured to remove a second substance (e.g., carbon dioxide) from the chamber 100 in a second mode. In one or more embodiments, vacuum system 144 in dual mode may include two or more vacuum pumps, wherein a first vacuum pump may be used to pressurize chamber 100 to a first vacuum power level under first mode and a second vacuum pump is used to pressurize chamber 100 to a second vacuum power level under second mode. For example, and without limitation, at least a vacuum system 144 may be configured to toggle between a first mode and a second mode by adjusting the power level supplied to the pump. As in this disclosure, “toggle” refers to a change in modes of the at least a vacuum system 144 based on power level input. In some cases, the first mode may correspond to a lower vacuum power level and the second mode corresponds to a high vacuum power level capable of generating a stronger vacuum pressure. In one or more embodiments, at least a vacuum system 144 is configured to operate in a mutually exclusive manner between a first mode and a second mode. That is, at least a vacuum system 144 may operate in only one mode at any given time. When at least a vacuum system 144 is operating in the first mode, the second mode is disabled, and vice versa.

With continued reference to FIG. 1, chamber 100 may be referred to as a dual mode carbon capture chamber because vacuum system 144 is configured to operate in at least two different vacuum modes during operation of chamber 100. In one or more embodiments, the two different vacuum modes may include a first vacuum mode and a second vacuum mode. During the first vacuum mode, vacuum system 144 may remove non-carbon dioxide gas, water vapor, or a combination thereof from interior 108 of chamber 100 while carbon dioxide remains adsorbed by adsorbent material of carbon capture structure 112. During the second vacuum mode, vacuum system 144 may remove carbon dioxide released from the adsorbent material after carbon capture structure 112 is heated by temperature control system 120. In one or more embodiments, the first vacuum mode and the second vacuum mode may differ by vacuum pressure, pumping power, pumping speed, pump type, gas flow path, valve configuration, operating temperature, material state of the adsorbent material, or any combination thereof.

With continued reference to FIG. 1, in one or more embodiments, chamber 100 may be in communication with two distinct vacuum pumps. A first vacuum pump may be used to evacuate the chamber under a first vacuum mode in order to remove waste gases prior to the carbon dioxide capture cycle. A second vacuum pump may be used under a second vacuum mode to generate a stronger vacuum suitable for the carbon dioxide collection cycle. In one or more embodiments, the first vacuum pump may be a primary pump operating in rough or low vacuum pressure ranges. In one or more embodiments, the second vacuum may be a secondary vacuum pump configured to operate in high, very high or ultra-high vacuum pressure ranges. As a non-limiting example, the primary pump may include oil sealed rotary vane pump, liquid ring pump, diaphragm pump, scroll pump, roots pump, claw pump, or screw pump. The secondary pump may include turbomolecular pump, vapor diffusion pump, cryopump, or sputter ion pump. In one or more embodiments, the vacuum pumps may operate in a mutually exclusive manner, such that only one vacuum pump is active at any given time. When the first vacuum pump may be operating, the second vacuum pump may be disabled and vice versa.

With continued reference to FIG. 1, in one or more embodiments, during a carbon capture state, air enters chamber 100 through selectively sealable air intake 128 and carbon dioxide from the air is adsorbed by the adsorbent material of the carbon capture structure. After adsorption of carbon dioxide, vacuum system 144 may operate in the first vacuum mode to remove non-carbon dioxide gas from interior 108 of chamber 100 while the carbon dioxide remains adsorbed by the adsorbent material. After removal of the non-carbon dioxide gas, temperature control system 120 may heat the carbon capture structure to release the carbon dioxide from the adsorbent material. Vacuum system 144 may then operate in the second vacuum mode to remove the released carbon dioxide from interior 108 of chamber 100.

With continued reference to FIG. 1, in one or more embodiments, temperature control system 120 may be configured to preheat carbon capture structure 112 before the first vacuum mode to desorb water vapor from the adsorbent material. For the purposes of this disclosure, “desorb” means to cause a substance previously adsorbed or absorbed by a material to leave the material. In one or more embodiments, water vapor may desorb from adsorbent material of carbon capture structure 112 during a preheating step before a first vacuum mode. In one or more embodiments, carbon dioxide may desorb from adsorbent material of carbon capture structure 112 when temperature control system 120 heats carbon capture structure 112 to a second mode temperature. In one or more embodiments, desorbed water vapor, carbon dioxide, non-carbon dioxide gas, or any combination thereof may be removed from interior 108 of chamber 100 by vacuum system 144. In one or more embodiments, the preheating may be performed at a temperature sufficient to desorb water vapor from the adsorbent material while carbon dioxide remains adsorbed by the adsorbent material. For example, the temperature control system 120 may provide heat to carbon capture structure 112 for a predetermined preheating period, or until a measured moisture level within chamber 100 satisfies a threshold condition. In one or more embodiments, the preheating may cause water molecules adsorbed by the adsorbent material to be released into interior 108 of chamber 100 before carbon dioxide is released from the adsorbent material. Vacuum system 144 may then operate in the first vacuum mode to remove the desorbed water vapor and non-carbon dioxide gas from interior 108 of chamber 100 before the carbon dioxide is released from the adsorbent material.

With continued reference to FIG. 1, removing water vapor before release of carbon dioxide may increase a purity of carbon dioxide subsequently collected during the second vacuum mode. In one or more embodiments, during the first vacuum mode, carbon dioxide may remain adsorbed by the adsorbent material while water vapor, nitrogen, oxygen, and/or other non-carbon dioxide gas is removed through waste gas outlet 148. After the water vapor and non-carbon dioxide gas are removed, temperature control system 120 may further heat carbon capture structure 112 to release carbon dioxide from the adsorbent material. Vacuum system 144 may then operate in the second vacuum mode to remove the released carbon dioxide from interior 108 of chamber 100 through carbon dioxide outlet 152. In this manner, chamber 100 may reduce an amount of water vapor entrained in the carbon dioxide removed during the second vacuum mode.

With continued reference to FIG. 1, the controller 172, as described in more detail below, may be configured to regulate the power input and operating modes to at least a vacuum system 144 in order to toggle between the first mode and the second mode based on measured system conditions such as carbon dioxide concentrations. In one or more embodiments, toggling between the first mode and the second mode may include adjusting the power level supplied to a single pump system. In one or more embodiments, toggling between the first mode and the second mode may include switching operation between two distinct vacuum pumps. In one or more embodiments, a first vacuum may be used to remove waste gas, such as oxygen and nitrogen, from chamber 100, wherein chamber 100 contains a vacuum with carbon dioxide adhered to one or more carbon capture structure 112. In one or more embodiments, preheating may occur before the first mode of at least a vacuum system 144 to remove water vapor from the chamber 100. In one or more embodiments, a second vacuum may then be used to pressurize and/or remove carbon dioxide after carbon dioxide has been released from the one or more carbon capture structure 112. In one or more embodiments, at least a vacuum system 144 may be configured to initially remove waste gas from the chamber 100, wherein heat is then applied to remove carbon dioxide from the one or more carbon capture structure 112, wherein a second vacuum is applied to remove the isolated carbon dioxide. In one or more embodiments, a second vacuum may extract a gaseous substance that contains a high concentration of carbon dioxide. In one or more embodiments, a high concentration may include a concentration of carbon dioxide higher than the initial concentration of carbon dioxide within the gas captured by the chamber 100. In one or more embodiments, a first mode of at least a vacuum system 144 may be used to remove gas, such as oxygen and nitrogen, from chamber 100, wherein chamber 100 contains a vacuum with carbon dioxide adhered to one or more carbon capture structure 112. In one or more embodiments, a second mode may then be used to pressurize and/or remove carbon dioxide after carbon dioxide has been released from the one or more carbon capture structure 112. In one or more embodiments, at least a vacuum system 144 may be configured to initially remove waste gas from the chamber 100 in the first mode, wherein a heat is then applied to remove carbon dioxide from the one or more carbon capture structure 112, wherein a second mode is applied to remove the isolated carbon dioxide. In one or more embodiments, prior to the second mode, the chamber 100 may be heated to a higher temperature in order to remove carbon dioxide from the one or more carbon capture structure 112. In one or more embodiments, a second mode may extract a gaseous substance that contains a high concentration of carbon dioxide. In one or more embodiments, a high concentration may include a concentration of carbon dioxide higher than the initial concentration of carbon dioxide within the gas captured by the chamber 100.

With continued reference to FIG. 1, in one or more embodiments, during a carbon capture state, air enters chamber 100 through selectively sealable air intake 128 and carbon dioxide from the air is adsorbed by the adsorbent material of the carbon capture structure. After adsorption of carbon dioxide, vacuum system 144 may operate in the first vacuum mode to remove non-carbon dioxide gas from interior 108 of chamber 100 while the carbon dioxide remains adsorbed by the adsorbent material. After removal of the non-carbon dioxide gas, temperature control system 120 may heat the carbon capture structure to release the carbon dioxide from the adsorbent material. Vacuum system 144 may then operate in the second vacuum mode to remove the released carbon dioxide from interior 108 of chamber 100.

With continued reference to FIG. 1, in the at least a vacuum system 144, the carbon dioxide outlet 152 may include a valve configured to direct carbonic substance released from one or more carbon capture structure 112 into a carbon dioxide collection system 156. A “carbon dioxide outlet” for the purpose of this disclosure refers to a device or a component thereof that facilitates the removal of carbon dioxide that is released from one or more carbon capture structures. In some cases, carbon dioxide outlet 152 may facilitate the removal of carbon dioxide that is released from one or more carbon capture structures when at least a vacuum is in the second mode or when at least a vacuum system 144 is operating under a second vacuum pump with a second vacuum power level. In one or more embodiments, the carbon dioxide outlet 152 may include an outlet valve 140 in order to regulate the volume of carbon dioxide exiting chamber 100. In one or more embodiments, an outlet valve 140 may include motors and/or solenoid valves that are configured to control the flow of carbon dioxide exiting chamber 100. In one or more embodiments, outlet valves may be controlled using a controller 172 as described in further detail below. In one or more embodiments, the carbon dioxide outlet 152 is maintained in a closed state when the vacuum pump is operating in the first mode or in the first vacuum pump with a first vacuum power level, thereby preventing the release of carbon dioxide during low-vacuum or waste gas elimination. The initial stream of carbon dioxide entering the collection system may contain water vapor released by one or more carbon capture structure 112. To improve the purity of the collected carbon dioxide, the system may include a heating unit configured to remove water vapor from the carbon dioxide stream. In one or more embodiments, the heating system 160 may be controlled by a controller 172 in response to sensor data indicating moisture levels. The heating system 160 may operate by increasing the temperature of the collected carbon dioxide to evaporate or separate residual water vapor prior to carbon dioxide storage in a cooling system 164 and/or carbon dioxide gas compression. The carbon dioxide collection system 156 may include a cooling system 164 configured to condense or liquefy carbon dioxide from a gaseous state to a liquid state. A cooling system 164 may be activated following the removal of water vapor by a heating unit, as described above. In one or more embodiments, the cooling system 164 may include a refrigeration unit, thermoelectric cooler (TEC), or cryogenic cooling loop configured to lower the temperature of the carbon dioxide below its condensation point under a given system pressure. After carbon dioxide is liquefied, the liquefied carbon dioxide is directed to a collection tank. In one or more embodiments, the carbon dioxide collection system 156 may include at least an outlet 168 configured to direct carbon dioxide into one or more pressurized tanks. In one or more embodiments, the chamber 100 may include a plurality of outlets configured to direct gas to different types of destinations. At least an outlet 168 may be in communication with the carbon dioxide collection system 156 and may be coupled to storage tanks via a sealed conduit or gas transfer line. In one or more embodiments, at least an outlet 168 may include a one-way valve, check valve, or pressure-regulating valve configured to control the flow of carbon dioxide into the storage tank while preventing backflow. In one or more embodiments, at least an outlet 168 may include quick-connect fittings, high-pressure rated hoses, or gas-tight seals to ensure safe transfer of carbon dioxide into the pressurized tank without leakage.

With continued reference to FIG. 1, chamber 100 includes a controller 172. For the purposes of this disclosure, a “controller” is one or more components or systems configured to control, coordinate, monitor, or otherwise regulate operation of one or more components of or associated with, a carbon capture chamber. In one or more embodiments, controller 172 may be configured to operate chamber 100 in a carbon capture state, a waste gas elimination state, and a carbon collection state. In one or more embodiments, controller 172 may be configured to generate and transmit one or more command signals to at least one of temperature control system 120, vacuum system 144, selectively sealable air intake 128, selectively sealable air exhaust 136, carbon dioxide collection system 156, one or more valves, one or more sensors, or any combination thereof. For the purposes of this disclosure, a “command signal” is a control signal generated to regulate operation of one or more components. In one or more embodiments, controller 172 may generate and transmit one or more command signals to at least one of temperature control system 120, vacuum system 144, selectively sealable air intake 128, selectively sealable air exhaust 136, intake valve 132, exhaust valve 140, waste gas outlet valve, carbon dioxide outlet valve, carbon dioxide collection system 156, heating system 160, cooling system 164, one or more sensors, or any combination thereof. In one or more embodiments, a command signal may cause a component to turn on, turn off, open, close, seal, unseal, heat, cool, pump, evacuate, vent, collect, compress, liquefy, transmit data, change an operating state, change an operating mode, change a flow rate, change a temperature, change a pressure, or any combination thereof.

With continued reference to FIG. 1, controller 172 may include any analog and/or digital components configured or assembled to perform functions as described below. Controller 172 may include, without limitation, an operational amplifier circuit, a combinational logic circuit, and/or a sequential logic circuit. Controller 172 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory may include a primary memory and a secondary memory. “Primary memory” also known as “random access memory” (RAM) for the purposes of this disclosure is a short-term storage device in which information is processed. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein circuitry may access the information from primary memory.

With continued reference to FIG. 1, controller 172 may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

Further referring to FIG. 1, controller 172 may include any computing device as described in this disclosure, including without limitation a microcontroller, microprocessor, digital signal processor (DSP) and/or system on a chip (SoC) as described in this disclosure. Controller 172 may include, be included in, and/or communicate with a mobile device such as a mobile telephone or smartphone. Controller 172 may include a single computing device operating independently, or may include two or more computing device operating in concert, in parallel, sequentially or the like; two or more computing devices may be included together in a single computing device or in two or more computing devices. Controller 172 may interface or communicate with one or more additional devices as described below in further detail via a network interface device. Network interface device may be utilized for connecting controller 172 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Controller 172 may include but is not limited to, for example, a computing device or cluster of computing devices in a first location and a second computing device or cluster of computing devices in a second location. Controller 172 may include one or more computing devices dedicated to data storage, security, distribution of traffic for load balancing, and the like. Controller 172 may distribute one or more computing tasks as described below across a plurality of computing devices of computing device, which may operate in parallel, in series, redundantly, or in any other manner used for distribution of tasks or memory between computing devices. Controller 172 may be implemented, as a non-limiting example, using a “shared nothing” architecture.

With continued reference to FIG. 1, controller 172 may be designed and/or configured to perform any method, method step, or sequence of method steps in any embodiment described in this disclosure, in any order and with any degree of repetition. For instance, controller 172 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller 172 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, in one or more embodiments, the controller 172 operates in at least one of a carbon capture state, a waste gas elimination state, or a carbon collection state. For the purposes of this disclosure, a “carbon capture state” is an operating state of a chamber in which air is received into the chamber and carbon dioxide from the air is adsorbed by adsorbent material of a carbon capture structure. In one or more embodiments, during the carbon capture state, selectively sealable air intake 128 and selectively sealable air exhaust 136 may be unsealed to permit airflow through chamber 100. In one or more embodiments, temperature control system 120 may set or maintain carbon capture structure 112 at a first mode temperature during the carbon capture state. For the purposes of this disclosure, a “waste gas elimination state” is an operating state of a chamber in which non-carbon dioxide gas, water vapor, or a combination thereof is removed from an interior of the chamber while carbon dioxide remains adsorbed by adsorbent material of a carbon capture structure. In one or more embodiments, during the waste gas elimination state, controller 172 may seal selectively sealable air intake 128 and selectively sealable air exhaust 136 and operate vacuum system 144 in a first vacuum mode. In one or more embodiments, during the waste gas elimination state, a waste gas outlet valve may be opened and a carbon dioxide outlet valve may be closed. For the purposes of this disclosure, a “carbon collection state” is an operating state of a chamber in which carbon dioxide released from adsorbent material of a carbon capture structure is removed from an interior of the chamber and directed toward a carbon dioxide collection system. In one or more embodiments, during the carbon collection state, controller 172 may seal selectively sealable air intake 128 and selectively sealable air exhaust 136 and operate vacuum system 144 in a second vacuum mode. In one or more embodiments, during the carbon collection state, temperature control system 120 may heat carbon capture structure 112 to release carbon dioxide from the adsorbent material, a waste gas outlet valve may be closed, and a carbon dioxide outlet valve may be opened.

With continued reference to FIG. 1, controller 172 may be configured to seal the selectively sealable air intake 128 and the selectively sealable air exhaust 136 when in a waste gas elimination state and operating in a first vacuum mode. In one or more embodiments, sealing the selectively sealable air intake 128 and the selectively sealable air exhaust 136 during the waste gas elimination state may prevent additional air from entering chamber 100 and may prevent gas from exiting through an undesired flow path while vacuum system 144 removes non-carbon dioxide gas from interior 108 of chamber 100. In one or more embodiments, the controller 172 may generate and transmit one or more command signals to vacuum system 144 to operate vacuum system 144 in the first vacuum mode during the waste gas elimination state. In one or more embodiments, operating vacuum system 144 in the first vacuum mode may include activating a first vacuum pump, setting a vacuum pump to a first vacuum power level, opening a waste gas outlet valve, closing a carbon dioxide outlet valve, or any combination thereof.

With continued reference to FIG. 1, the controller 172 may be configured to seal the selectively sealable air intake 128 and the selectively sealable air exhaust 136 when in a carbon collection state and operating in a second vacuum mode. In one or more embodiments, sealing the selectively sealable air intake 128 and the selectively sealable air exhaust 136 during the carbon collection state may isolate interior 108 of chamber 100 from an external environment while carbon dioxide released from adsorbent material of carbon capture structure 112 is removed from chamber 100. In one or more embodiments, the controller 172 may generate and transmit one or more command signals to vacuum system 144 to operate vacuum system 144 in the second vacuum mode during the carbon collection state. In one or more embodiments, operating vacuum system 144 in the second vacuum mode may include activating a second vacuum pump, setting a vacuum pump to a second vacuum power level greater than a first vacuum power level, closing a waste gas outlet valve, opening a carbon dioxide outlet valve, or any combination thereof. In one or more embodiments, the controller 172 may be configured to unseal both the selectively sealable air intake 128 and the selectively sealable air exhaust 136 during the carbon capture state to permit airflow through chamber 100, such that air received through selectively sealable air intake 128 passes through or across carbon capture structure 112 and exits through selectively sealable air exhaust 136 after carbon dioxide from the air has been adsorbed by the adsorbent material.

With continued reference to FIG. 1, chamber 100 may include a plurality of sensors disposed in the chamber 100. In one or more embodiments, the sensors may be configured to measure carbon dioxide concentrations within the chamber 100 during operation. In one or more embodiments, a plurality of sensors may include a nondispersive infrared sensor capable of detecting the presence and concentrations of carbon dioxide. In one or more embodiments, a plurality of sensors may be in communication with a controller 172 and configured to transmit real-time measurement data. Controller 172 may analyze sensor input to determine the appropriate operational state of the system. For example, and without limitation, when carbon dioxide concentrations reach a predefined threshold, the controller 172 may transmit one or more command signals to activate or adjust the system. In one or more embodiments, the controller 172 may transmit signals to the temperature control system 120 to initiate heating or cooling cycles for carbon capture processes. In one or more embodiments, the controller 172 may transmit signals to the carbon dioxide collection system 156 to begin collecting released carbon dioxide.

With continued reference to FIG. 1, a plurality of sensors may include at least a moisture sensor. “Moisture,” as used in this disclosure, is the presence of water, which may include vaporized water in air, condensation on the surfaces of objects, or concentrations of liquid water. Moisture may include humidity. “Humidity,” as used in this disclosure, is the property of a gaseous medium (such as air) to hold water in the form of vapor. In an embodiment, a moisture sensor may include a hygrometer. An amount of water vapor contained within a parcel of air can vary significantly. Water vapor is generally invisible to the human eye and may be damaging to electrical components. There are three primary measurements of humidity: absolute, relative, and specific humidity. “Absolute humidity,” for the purpose of this disclosure, describes the water content of air and is expressed in either grams per cubic meter or grams per kilogram. “Relative humidity,” for the purpose of this disclosure, is expressed as a percentage, indicating a present stat of absolute humidity relative to maximum humidity given the same temperature. “Specific humidity,” for the purpose of this disclosure, is the ratio of water vapor mass to total moist air parcel mass, where parcel is a given portion of a gaseous medium. Humidity sensor may be psychrometer. Humidity sensor may be a hydrometer. Humidity sensor may be configured to act as or include a humidistat. A “humidistat,” for the purpose of this disclosure, is a humidity-triggered switch, often used to control another electronic device. Humidity sensor may use capacitance to measure relative humidity and include it in itself, or as an external component, include a device to convert relative humidity measurement to absolute humidity measurements. In one or more embodiments, the chamber 100 may include at least a moisture sensor configured to measure moisture datum of carbon dioxide capture. A “moisture datum” for the purpose of this disclosure is information associated with the moisture within a chamber. In one or more embodiments, moisture datum may be used to identify the presence of water molecules within the chamber 100 during adsorption and/or absorption of carbon dioxide. In one or more embodiments, during adsorption and/or absorption, water molecules may attach and/or adsorb/absorb to carbon capture material and/or other portions of the chamber 100. In one or more embodiments, at least moisture sensor may be configured to sense and/or generate moisture datum by identifying the amount of moisture within the chamber 100.

With continued reference to FIG. 1, in one or more embodiments, chamber 100 may be one of a plurality of dual mode carbon capture chambers. The plurality of dual mode carbon capture chambers may be operated asynchronously, such that at least one chamber operates in the carbon capture state while another chamber operates in the first vacuum mode or the second vacuum mode. In one or more embodiments, asynchronous operation of the plurality of chambers may permit continuous airflow through at least a portion of a carbon capture system while one or more other chambers undergo waste gas elimination, carbon dioxide collection, maintenance, repair, or replacement. In one or more embodiments, the plurality of dual mode carbon capture chambers may be arranged in parallel fluid paths, such that air is routed through a first chamber operating in the carbon capture state while a second chamber is sealed and operated in the first vacuum mode to remove non-carbon dioxide gas and/or water vapor and while a third chamber is sealed and operated in the second vacuum mode to remove carbon dioxide released from an adsorbent material. In one or more embodiments, one or more valves, dampers, manifolds, fans, ducts, or flow-routing components may be used to selectively direct air to a chamber that is available for carbon capture while isolating another chamber undergoing waste gas elimination or carbon collection. As a non-limiting illustrative example, a carbon capture system may include a first chamber, a second chamber, and a third chamber. During a first time period, the first chamber may receive air through a selectively sealable air intake and operate in the carbon capture state, the second chamber may be sealed and operated in the first vacuum mode to remove non-carbon dioxide gas while carbon dioxide remains adsorbed by an adsorbent material, and the third chamber may be heated and operated in the second vacuum mode to collect released carbon dioxide. During a second time period, the operating states of the first, second, and third chambers may rotate, such that the first chamber enters the waste gas elimination state, the second chamber enters the carbon collection state, and the third chamber is cooled and returned to the carbon capture state. In this manner, the plurality of dual mode carbon capture chambers may provide substantially continuous carbon capture while individual chambers cycle through adsorption, waste gas elimination, carbon dioxide release, carbon dioxide collection, cooling, maintenance, repair, or replacement.

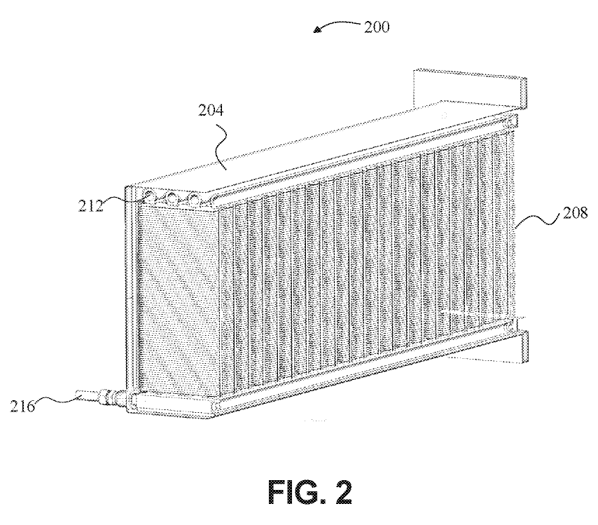

Referring now to FIG. 2, an exemplary embodiment of a cross-sectional view of a carbon capture chamber 200 is illustrated. In one or more embodiments, carbon capture chamber 200 may also be referred as a “carbon capture system.” In one or more embodiments, carbon capture chamber 200 may serve as an active carbon capture system, wherein carbon capture chamber 200 may be configured to adsorb and/or absorb carbon dioxide. In one or more embodiments, a gas such as air is blown through the carbon capture chamber 200. In one or more embodiments, carbon capture chamber 200 may include one or more walls 204 that are used to provide a structure to carbon capture chamber 200. In one or more embodiments, one or more walls 204 may ensure that carbon capture chamber 200 is capable of providing a sealed environment from the atmosphere. In one or more embodiments, one or more walls 204 may provide structural rigidity such that carbon capture chamber 200 does not collapse or buckle under negative pressure. In one or more embodiments, carbon capture chamber 200 may be similar to that of a container, wherein one or more walls 204 may provide the structure of the container. In one or more embodiments, one or more walls 204 may be made of a structurally rigid material such as aluminum, copper, a metal, a metal alloy, and/or the like. In one or more embodiments, one or more walls 204 may be made of thermally conductive materials in order to facilitate a heat transfer between an inside of carbon capture chamber 200 and outside of carbon capture chamber 200.

With continued reference to FIG. 2, the carbon capture chamber 200 may include a plurality of fins 208 made of a thermally conductive material, such as thermally conductive material as described in this disclosure. In one or more embodiments, the plurality of fins 208 may include and/or be included in a material body as described in reference to at least FIG. 1. In one or more embodiments, the plurality of fins may include a thermally conductive material such as any material as described in this disclosure which contains thermal properties capable of transferring heat. In one or more embodiments, the thermally conductive material may be covered and/or coated with an adsorbent and/or absorbent material that carbon dioxide will attach to at a low temperature. In one or more embodiments, the thermally conductive material may provide for efficient heat transfer between the adsorbent and/or absorbent material and the thermally conductive material in order to facilitate an adsorption or desorption process. In one or more embodiments, once the carbon dioxide is adsorbed and/or absorbed to the adsorbent and/or absorbent material, the air may be sucked out of carbon capture chamber 200 using a vacuum system such as any vacuum system as described in this disclosure. The vacuum system may expel any air within carbon capture chamber 200 while leaving the carbon dioxide which remains adsorbed and/or absorbed to the adsorbent and/or absorbent material. In one or more embodiments, the plurality of fins may be heated up in order to facilitate carbon dioxide release. In one or more embodiments, air may transfer through a plurality of fins 208, wherein carbon dioxide may adsorb and/or absorb to a surface of fins during the transfer. In one or more embodiments, a plurality of fins 208 may include adsorbent and/or absorbent material as described in reference to at least FIG. 1. In one or more embodiments, a plurality of fins 208 may provide for increased surface area between air passing through carbon capture chamber 200. In one or more embodiments, a plurality of fins 208 may include substantially planar surface in which air passes through and adsorbs and/or absorbs to a surface of the plurality of fins. In one or more embodiments, a plurality of fins 208 may include a plurality of sheets stacked above one another and spaced evenly to allow for air to pass through the sheets. In one or more embodiments, a plurality of fins 208 may include a structurally rigid material such as metal or metal alloy in order to contain a pressure within carbon capture chamber 200. In one or more embodiments, a plurality of fins 208 may include substantially planar sheets that allow for maximum surface area contact between air and an adsorbent and/or absorbent coating on a plurality of fins 208. In one or more embodiments, heating of the plurality of fins will allow for heat to transfer to adsorbent and/or absorbent material and thereby cause increased molecular activity which will result in the release of carbon dioxide from adsorbent and/or absorbent material. In one or more embodiments, a plurality of fins 208 may be heated by pumping hot water through pipes thermally connected to the plurality of fins. This process may release the carbon dioxide into the surrounding atmosphere of the carbon capture chamber 200. In one or more embodiments, a second vacuum is then used to expel the carbon dioxide in the carbon capture chamber 200. In one or more embodiments, following release of carbon dioxide, the carbon dioxide may be suspended in a gaseous format, where a vacuum may be used to retrieve the gaseous format from the chamber. In one or more embodiment, following removal of carbon dioxide, the plurality of fins may be cooled (e.g., using cold water and/or a heat exchanger as described in this disclosure) and carbon capture chamber 200 is repressurized and/or reopened in order to accept new air and restart the carbonic cycle.

With continued reference to FIG. 2, in one or more embodiments, a plurality of fins 208 may extend laterally across carbon capture chamber 200 from an inlet to an outlet. In one or more embodiments, the inlet may be defined as the location at which air and/or gas enters carbon capture chamber 200, wherein outlet may be defined as the location at which air or gas leaves carbon capture chamber 200.

With continued reference to FIG. 2, a system as described in reference to FIG. 1 may utilize multiple chambers permitting some carbon capture chambers 200 to run adsorption and/or absorption cycles while others are desorbing (pulling vacuum). Such a process would allow continuous airflow. In addition, such as process would allow for individual modules (also referred to as “individual carbon capture chambers”) to be taken offline for repair or swapped with replacements while the system continues to operate. Downstream, the carbon dioxide may be further purified by removing water vapor and the cooled to form liquid or pumped into pressurized tanks. The whole system can be integrated into a datacenter that uses air (at least partially) to cool servers/computers, or any other setup where air has to be moved through for other reasons, such as, but not limited to, an apartment or office buildings with active ventilation/HVAC systems. In one or more embodiments, the system described herein may be implemented and/or integrated into data centers and/or existing devices that utilize airflow in order to remove carbon dioxide from the air flowing through said devices.

With continued reference to FIG. 2, carbon capture chambers 200 may include a plurality of tubes 212. In one or more embodiments, a plurality of tubes 212 may serve as a component of heating element and/or heat exchanger as described in this disclosure. In one or more embodiments, heated glass and/or fluids may flow through a plurality of tubes 212 in order to provide heat to carbon capture chambers 200. In one or more embodiments, carbon capture chambers 200 may be heated through conduction, wherein heat from liquids such as water may heat a plurality of tubes 212 and heat from tubes may be transferred to a plurality of fins 208. In one or more embodiments, a plurality of tubes 212 and a plurality of fins 208 may contain a thermally conductive material that allows for heat to transfer between a plurality of tubes 212 and a plurality of fins 208. In one or more embodiments, a plurality of tubes 212 may be configured to hold a cooled liquid as well, wherein the cooled liquid may absorb heat from carbon capture chambers 200 and a plurality of fins 208. In one or more embodiments, liquids may flow within a plurality of tubes 212 through the use of a cooling pump and/or a heating pump.

With continued reference to FIG. 2, it may be the case that vacuum chambers require significant structural strength, or they may risk implosion due to pressure differences caused by the use of a vacuum. Such as implosion may be mitigated through the use of thick sidewalls, reinforcing ribs, and/or particular (e.g., cylindrical) shapes. In one or more embodiments, carbon capture chambers 200 may include a plurality of fins 208 and/or a plurality of tubes 212 that can both facilitate in the carbonic cycle and simultaneously provide structural support to carbon capture chambers 200. In one or more embodiments, carbon capture chambers 200 may be designed with much thinner walls that will “suck onto” the plurality of fins/the plurality of tubes when the vacuum is pulled and be held there against collapse(transverse) or buckling (longitudinal). In one or more embodiments, the use of a plurality of fins 208 and a plurality of tube to provide structural support will ensure that the only place where thicker material is needed is on the ends (e.g., the inlet and outlet) of the carbon capture chambers 200. This can work on any transverse cross-sectional shape, but is especially useful for rectangular cross-sections, which are cheap to make and easy to fill: better for cost-effective and reliable mass production. The walls could be made from the sort of plastic used for vacuum sealing but will probably be metal or a heat-resistant hard plastic.

With continued reference to FIG. 2, both the plurality of fins and the plurality of tubes can provide support for the walls of carbon capture chambers 200. In one or more embodiments, the plurality of fins may provide structural support from side to side, while the plurality of tubes provides structural support perpendicularly to the plurality of fins and from top to bottom. As the vacuum chamber gets bigger and bigger, the walls have to get increasingly thicker. In one or more embodiments, use of a plurality of fins 208 and a plurality of tubes 212 as structural support for carbon capture chamber 200 may allow for an increase in size to carbon capture chambers 200 without decreasing structural rigidity of carbon capture chambers 200. In one or more embodiments, a vacuum chamber without internals such as a plurality of fins 208 and ribs may collapse when increased in size due to structural deficiencies. In one or more embodiments, a plurality of fins 208 and a plurality of tubes 212 may perform the thermal exchange/adsorption process while providing structural rigidity to carbon capture chambers 200 as well. In one or more embodiments, a plurality of fins 208 may fill the chamber transversely, while a plurality of tubes 212 fill carbon capture chambers 200 vertically, to provide (in a first direction and a second direction) structural integrity against negative pressure.

With continued reference to FIG. 2, carbon capture chambers 200 may include a heat exchanger and/or heating component 216 as described in reference to at least FIG. 1. In one or more embodiments, heating component 216 may include a heat transfer structure. The heat transfer structure may also serve as a structural member contacting the external walls and taking the loads (e.g., by preventing buckling). In one or more embodiments, the heat transfer structure may include any material that is thermally conductive. This may include any material as described in this disclosure. In one or more embodiments, thermally conductive material may further include copper or aluminum. Rails could be anything (aluminum is easy to machine, or stainless, or plastic (able to take high temperature- like cpvc, nylon, peak; 92℃ or as low as 50℃ to 60℃). Exterior walls of carbon capture chambers 200 could be stainless, aluminum, or even plastic (could be quite weak, as thin as plastic bag such as a high-tensile plastic bag). In one or more embodiments, heating components 216 may include and/or be fluidly connected to a plurality of tube 212, wherein a fluid from heating component 216 may flow through tubes 212.

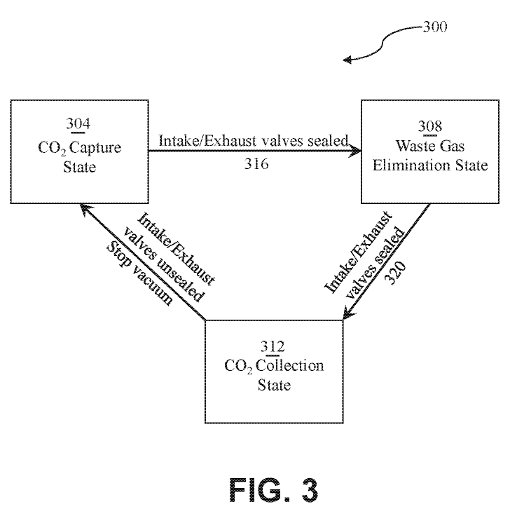

Referring now to FIG. 3, an exemplary embodiment 300 of various operational states of chamber 100 are illustrated. Operational states may be illustrated, for exemplary purposes, as a state machine, transitioning between a CO₂ capture state 304, a waste gas elimination state 308 and/or a CO₂ collection state 312. In the CO₂ capture state 304, both the intake and exhaust valves may be unsealed to allow air to enter the chamber 100. In one or more embodiments, at least a vacuum pump is inactive in the CO₂capture state 304. In one or more embodiments, a temperature control system may be configured to operate in the CO₂ capture state 304 under a first mode, wherein the first mode temperature may range from approximately 5℃ to 35℃ for CO₂ capture via adsorption and/or absorption. In one or more embodiments, the carbon dioxide outlet is closed during the CO₂ capture state 304. In the waste gas elimination state 308, both the intake and exhaust valves may be sealed to retain air within chamber 100. In one or more embodiments, at least a vacuum pump may be active during the waste gas elimination state 308, operating at a first vacuum power level 316 configured to remove gases other than carbon dioxide through a selectively sealable air exhaust. In one or more embodiments, at least a vacuum pump may operate at a second vacuum power level 320 configured to direct CO₂ into carbon dioxide collection system. In one or more embodiments, the temperature control system may be configured to preheat chamber 100 prior to activation of the first vacuum power level 316, thereby removing water vapor before the first vacuum power level 316 is on. In one or more embodiments, the carbon dioxide outlet is closed during the waste gas elimination state 308. In the CO₂ collection state 312, both the intake and exhaust valves may be sealed to retain the released carbon dioxide within chamber 100 prior to its redirection into a carbon dioxide collection system. In one or more embodiments, a temperature control system may be configured to operate in the CO₂collection state 312 under a second mode, wherein the second mode temperature may range from approximately 85℃ to 258℃ for CO₂ release. In one or more embodiments, a carbon dioxide outlet may be opened during the CO₂ collection state 312 to direct the released carbon dioxide into a carbon dioxide collection system under a second vacuum power level 320. In one or more embodiments, the carbon dioxide collection system may include a heating system configured to remove water vapor from the carbon dioxide collected from the CO₂ collection state 312 before the purified carbon dioxide is directed into one or more pressurized tanks for storage. In one or more embodiments, the carbon dioxide collection chamber may include a cooling system that liquefy the gaseous carbon dioxide collected from the CO₂ collection state 312 for future use. Upon completion of the CO₂ collection state 312, both the intake and exhaust valves may be unsealed, and the at least a vacuum pump may be deactivated to transition chamber 100 back into the CO₂ capture state 304.

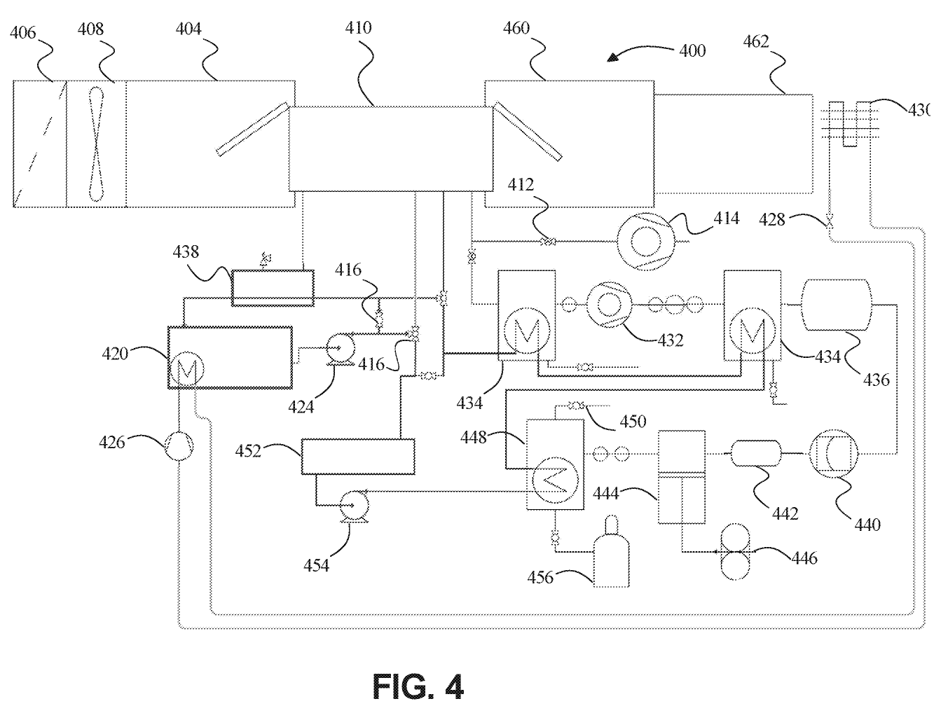

Referring now to FIG. 4, an exemplary direct air capture system 400 including one or more dual mode carbon capture chambers is illustrated. In one or more embodiments, direct air capture system 400 may include an inlet plenum 404 configured to receive and distribute incoming air before the air enters a capture chamber 410. In one or more embodiments, incoming air may pass through an inlet air filter 406 before entering inlet plenum 404. Inlet air filter 406 may be configured to remove dust, particulate matter, debris, or other materials from the incoming air before the incoming air reaches capture chamber 410. In one or more embodiments, a primary fan 408 may be configured to pull, push, or otherwise direct air through inlet air filter 406, through inlet plenum 404, and toward capture chamber 410. In one or more embodiments, inlet plenum 404 may distribute the incoming air across an inlet side of capture chamber 410 to reduce turbulence, reduce pressure differentials, and/or promote more uniform contact between the incoming air and adsorbent material within capture chamber 410.

With continued reference to FIG. 4, capture chamber 410 may include one or more carbon capture structures as described herein. In one or more embodiments, capture chamber 410 may include one or more fins, contactors, heating channels, cooling channels, tubes, adsorbent materials, or any combination thereof. In one or more embodiments, capture chamber 410 may operate in a carbon capture state in which air flows through capture chamber 410 and carbon dioxide from the air is adsorbed by an adsorbent material. After the carbon capture state, capture chamber 410 may be sealed, and pump valve 412 may be opened to fluidly connect capture chamber 410 to purge vacuum pump 414. Purge vacuum pump 414 may be configured to operate as part of a first vacuum mode to remove non-carbon dioxide gas, water vapor, or a combination thereof from capture chamber 410 while carbon dioxide remains adsorbed by the adsorbent material. In one or more embodiments, purge vacuum pump 414 may correspond to, or be included in, vacuum system 144 described with reference to FIG. 1.

With continued reference to FIG. 4, after at least a portion of non-carbon dioxide gas is removed from capture chamber 410, hot water valves 416 may be opened to permit heated fluid from hot tank 420 to flow into one or more heating lines, tubes, channels, or heat-transfer structures thermally coupled to capture chamber 410. In one or more embodiments, heat pump 424 may circulate heated fluid from hot tank 420 through hot water valves 416 and into capture chamber 410. In one or more embodiments, heat pump compressor 426 may compress a refrigerant or other working fluid to generate heat for hot tank 420. The working fluid may then pass through expansion valve 428 and one or more heat exchanger coils 430 as part of a thermal cycle used to heat the fluid stored in hot tank 420. In one or more embodiments, the heated fluid may preheat an adsorbent material within capture chamber 410 to desorb water vapor while carbon dioxide remains adsorbed by the adsorbent material. Purge vacuum pump 414 may remain connected to capture chamber 410 during at least a portion of the preheating operation to remove desorbed water vapor before carbon dioxide is released from the adsorbent material.

With continued reference to FIG. 4, after water vapor and/or non-carbon dioxide gas has been removed from capture chamber 410, pump valve 412 may be closed and extraction pump 432 may be fluidly connected to capture chamber 410. Extraction pump 432 may be configured to operate as part of a second vacuum mode to remove carbon dioxide released from the adsorbent material after capture chamber 410 is heated. In one or more embodiments, extraction pump 432 may generate a stronger vacuum than purge vacuum pump 414, a lower absolute pressure than purge vacuum pump 414, a greater pressure differential relative to ambient pressure than purge vacuum pump 414, or any combination thereof. In one or more embodiments, one or more condensers 434 may be positioned upstream and/or downstream of extraction pump 432 to condense water vapor, reduce gas volume, cool gas flowing through the system, or otherwise condition carbon dioxide removed from capture chamber 410. Carbon dioxide removed by extraction pump 432 may be directed to an intermittent buffer vessel 436 before further compression, drying, cooling, liquefaction, storage, or other downstream processing.

With continued reference to FIG. 4, in one or more embodiments, direct air capture system 400 may include a steam generator 438 configured to introduce steam into capture chamber 410 during at least a portion of a desorption cycle. Steam from steam generator 438 may reduce a partial pressure of carbon dioxide within capture chamber 410, accelerate desorption of carbon dioxide from the adsorbent material, purge one or more flow paths, or otherwise assist carbon dioxide removal. In one or more embodiments, carbon dioxide received in intermittent buffer vessel 436 may be directed to a carbon dioxide compressor 440. Carbon dioxide compressor 440 may be configured to compress the carbon dioxide to an intermediate pressure. The compressed carbon dioxide may then pass through a desiccant bed 442 configured to remove residual water from the carbon dioxide. In one or more embodiments, the carbon dioxide may then be directed to pressure amplifier 444, which may be powered or assisted by air compressor 446, to further increase a pressure of the carbon dioxide.

With continued reference to FIG. 4, pressurized carbon dioxide may be directed to carbon dioxide condenser 448. Carbon dioxide condenser 448 may cool the pressurized carbon dioxide to condense, liquefy, or otherwise condition the carbon dioxide for storage. In one or more embodiments, carbon dioxide condenser 448 may include purge valve 450 configured to remove impurities, non-condensable gas, residual gas, or headspace gas from carbon dioxide condenser 448. Carbon dioxide condenser 448 may receive cooled fluid from cold tank 452. Cold pump 454 may circulate cooled fluid from cold tank 452 to carbon dioxide condenser 448, one or more condensers 434, capture chamber 410, or any combination thereof. In one or more embodiments, cooled fluid from cold tank 452 may be used to cool capture chamber 410 after carbon dioxide has been removed so that capture chamber 410 may return to a carbon capture state. Condensed or liquefied carbon dioxide may be directed from carbon dioxide condenser 448 to holding tank 456 for storage, transport, sequestration, reuse, or further processing.

With continued reference to FIG. 4, direct air capture system 400 may include an outlet plenum 460 coupled to an outlet side of capture chamber 410. In one or more embodiments, outlet plenum 460 may receive air exiting capture chamber 410 after at least a portion of carbon dioxide has been adsorbed by the adsorbent material. Outlet plenum 460 may direct the exiting air to an exhaust duct, external environment, downstream airflow path, data-center airflow path, heating/cooling system, or other destination. In one or more embodiments, during a carbon capture state, air may flow from inlet plenum 404, through capture chamber 410, and into outlet plenum 460. During a first vacuum mode or second vacuum mode, capture chamber 410 may be sealed from inlet plenum 404 and outlet plenum 460.

With continued reference to FIG. 4, direct air capture system 400 may include a DAC control system 462. DAC control system 462 may be configured to control, coordinate, or monitor operation of one or more components of direct air capture system 400, including inlet air filter 406, primary fan 408, pump valve 412, purge vacuum pump 414, hot water valves 416, heat pump 424, heat pump compressor 426, expansion valve 428, extraction pump 432, condensers 434, steam generator 438, carbon dioxide compressor 440, pressure amplifier 444, air compressor 446, carbon dioxide condenser 448, purge valve 450, cold pump 454, and one or more valves, sensors, pumps, fans, heaters, coolers, or flow-control components. In one or more embodiments, DAC control system 462 may operate capture chamber 410 in a carbon capture state, a waste gas elimination state, and a carbon collection state. In one or more embodiments, DAC control system 462 may coordinate the opening and closing of valves, operation of purge vacuum pump 414 and extraction pump 432, heating of capture chamber 410 using hot tank 420, cooling of capture chamber 410 using cold tank 452, and downstream conditioning of carbon dioxide for storage in holding tank 456.

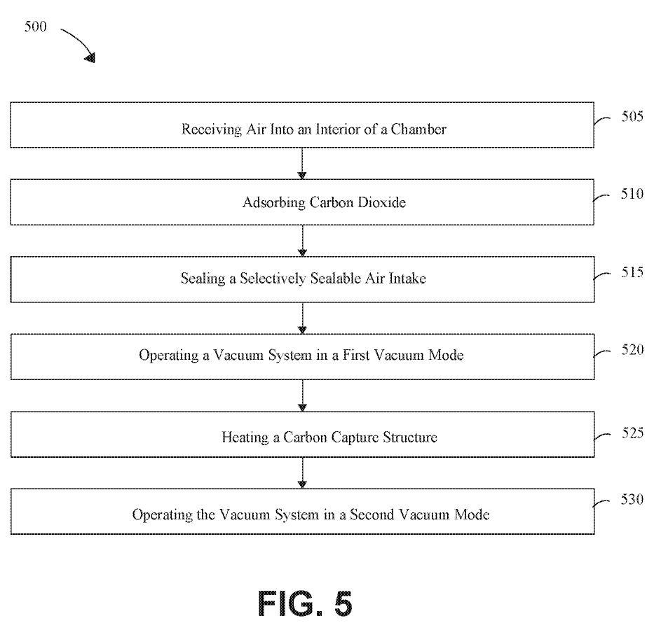

Referring now to FIG. 5, a flow diagram of an exemplary method 500 of operating a dual mode carbon capture chamber is illustrated. Method 500 contains a step 505 of receiving air into an interior of a chamber through a selectively sealable air intake during a carbon capture state, wherein a carbon capture structure disposed within the interior comprises an adsorbent material configured to adsorb carbon dioxide from the air. This may be implemented as described and with reference to FIGS. 1-4.

With continued reference to FIG. 5, method 500 contains a step 510 of adsorbing, using the adsorbent material, carbon dioxide from the air received in the chamber. This may be implemented as described and with reference to FIGS. 1-4.

With continued reference to FIG. 5, method 500 contains a step 515 of sealing the selectively sealable air intake and a selectively sealable air exhaust. This may be implemented as described and with reference to FIGS. 1-4.

With continued reference to FIG. 5, method 500 contains a step 520 of operating a vacuum system in a first vacuum mode to remove non-carbon dioxide gas from the interior while the carbon dioxide remains adsorbed by the adsorbent material. This may be implemented as described and with reference to FIGS. 1-4.

With continued reference to FIG. 5, method 500 contains a step 525 of heating, using a temperature control system thermally coupled to the carbon capture structure, the carbon capture structure to release the carbon dioxide from the adsorbent material. This may be implemented as described and with reference to FIGS. 1-4.

With continued reference to FIG. 5, method 500 contains a step 530 of operating the vacuum system in a second vacuum mode to remove the released carbon dioxide from the interior. This may be implemented as described and with reference to FIGS. 1-4.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

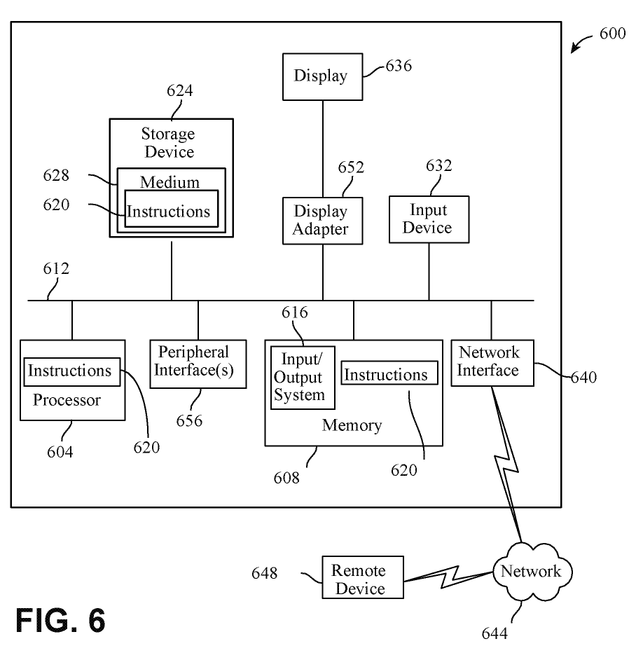

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a controller or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulpo’s algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof. Memory 608 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In some embodiments, storage device 624 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or more remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display 636. Examples of a display device include, but are not limited to, a liquid crystal display (LCD), a cathode ray tube (CRT), a plasma display, a light emitting diode (LED) display, and any combinations thereof. Display adapter 652 and display 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

Further referring to FIG. 6, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 6, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 6, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 600, processor 604, and memory 608 may be virtualized; that is, a virtual machine and/or container may interact directly with such computing system 600, processor 604, and/or memory 608, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 604 comprises a plurality of processors and/or processor cores, virtualization may, in some cases, simulate or emulate a single (virtual) processor whose functions are allocated to one or more of the plurality of processors and/or processor cores. In this case, while processor 604 may be said to be virtualized, the processor 604, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU; (2) VMware by Broadcom Inc of Palo Alto, California; (3) VirtualBox by Oracle Corporation headquartered in Austin, Texas; and (6) kernel-based virtual machine (KVM).

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve systems according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A dual mode carbon capture chamber, the chamber comprising:
at least an exterior wall defining an interior of the chamber;
a carbon capture structure disposed within the interior of the chamber, wherein the carbon capture structure comprises an adsorbent material configured to adsorb carbon dioxide from air received in the chamber;
a selectively sealable air intake configured to permit the air to enter the chamber during a carbon capture state;
a selectively sealable air exhaust configured to permit gas to exit the chamber;
a temperature control system thermally coupled to the carbon capture structure, wherein the temperature control system is configured to heat the carbon capture structure; and
a vacuum system in fluid communication with the interior of the chamber, wherein the vacuum system is configured to operate in a first vacuum mode and a second vacuum mode, wherein:
the vacuum system is configured, in the first vacuum mode, to remove non-carbon dioxide gas from the interior of the chamber while the carbon dioxide remains adsorbed by the adsorbent material; and
the vacuum system is configured, in the second vacuum mode, to remove the carbon dioxide released from the adsorbent material after the carbon capture structure is heated by the temperature control system.

2. The dual mode carbon capture chamber of claim 1, wherein the at least an exterior wall is configured to withstand a vacuum pressure within the chamber.

3. The dual mode carbon capture chamber of claim 1, wherein the carbon capture structure comprises at least a fin made of a thermally conductive material, wherein the adsorbent material is disposed on the at least a fin.

4. The dual mode carbon capture chamber of claim 1, wherein the temperature control system is configured to:
set a first mode temperature for carbon dioxide capture by the adsorbent material, wherein the adsorbent material is configured to adsorb carbon dioxide at the first mode temperature; and
set a second mode temperature for carbon dioxide release from the adsorbent material.

5. The dual mode carbon capture chamber of claim 4, wherein the temperature control system comprises a heat exchanger configured to transfer heat to the carbon capture structure through conduction, wherein the heat exchanger comprises one or more tubes thermally coupled to the carbon capture structure, wherein the one or more tubes are configured to:
receive a heated fluid to heat the carbon capture structure; and
receive a cooled fluid to cool the carbon capture structure after the carbon dioxide is removed from the chamber during the second vacuum mode.

6. The dual mode carbon capture chamber of claim 1, wherein the selectively sealable air intake comprises an intake valve configured to control an amount of the air entering the chamber.

7. The dual mode carbon capture chamber of claim 1, wherein the selectively sealable air exhaust comprises an exhaust valve configured to control an amount of the gas exiting the chamber.

8. The dual mode carbon capture chamber of claim 1, wherein the vacuum system comprises:
a waste gas outlet configured to output the non-carbon dioxide gas from the chamber during the first vacuum mode; and
a carbon dioxide outlet configured to output the carbon dioxide from the chamber during the second vacuum mode.

9. The dual mode carbon capture chamber of claim 8, wherein the waste gas outlet comprises a waste gas outlet valve configured to control an amount of the non-carbon dioxide gas exiting the chamber during the first vacuum mode, wherein the waste gas outlet valve of the waste gas outlet is closed during the second vacuum mode.

10. The dual mode carbon capture chamber of claim 8, wherein the carbon dioxide outlet comprises a carbon dioxide outlet valve configured to direct the carbon dioxide released from the adsorbent material into a carbon dioxide collection system during the second vacuum mode, wherein the carbon dioxide outlet valve of the carbon dioxide outlet is closed during the first vacuum mode.

11. The dual mode carbon capture chamber of claim 10, wherein the carbon dioxide collection system comprises:
a heating system configured to remove water vapor from the carbon dioxide;
a cooling system configured to liquefy the carbon dioxide; and
an outlet configured to direct the carbon dioxide into one or more pressurized tanks.

12. The dual mode carbon capture chamber of claim 1, wherein the vacuum system is configured to generate a first vacuum pressure during the first vacuum mode and a second vacuum pressure during the second vacuum mode, wherein the second vacuum pressure is greater than the first vacuum pressure.

13. The dual mode carbon capture chamber of claim 1, wherein the dual mode carbon capture chamber further comprises:
a controller configured to operate the dual mode carbon capture chamber in the carbon capture state, a waste gas elimination state, and a carbon collection state.

14. The dual mode carbon capture chamber of claim 13, wherein the controller is configured to:
seal the selectively sealable air intake and the selectively sealable air exhaust during the waste gas elimination state; and
operate the vacuum system in the first vacuum mode.

15. The dual mode carbon capture chamber of claim 13, wherein the controller is configured to:
seal the selectively sealable air intake and the selectively sealable air exhaust during the carbon collection state; and
operate the vacuum system in the second vacuum mode.

16. The dual mode carbon capture chamber of claim 13, wherein the controller is configured to unseal the selectively sealable air intake and the selectively sealable air exhaust during the carbon capture state to permit airflow through the chamber.

17. The dual mode carbon capture chamber of claim 13, wherein the controller is configured to generate and transmit one or more command signals to at least one of the temperature control system or the vacuum system.

18. The dual mode carbon capture chamber of claim 1, wherein:
the temperature control system is configured to preheat the carbon capture structure before the first vacuum mode to desorb water vapor from the adsorbent material; and
the vacuum system is configured, in the first vacuum mode, to remove the water vapor from the interior of the chamber before the carbon dioxide is released from the adsorbent material.

19. The dual mode carbon capture chamber of claim 1, wherein the dual mode carbon capture chamber is one of a plurality of dual mode carbon capture chambers configured such that at least one chamber operates in the carbon capture state while another chamber operates in the first vacuum mode or the second vacuum mode.

20. A method of operating a dual mode carbon capture chamber, the method comprising:
receiving air into an interior of a chamber through a selectively sealable air intake during a carbon capture state, wherein a carbon capture structure disposed within the interior comprises an adsorbent material configured to adsorb carbon dioxide from the air;
adsorbing, using the adsorbent material, carbon dioxide from the air received in the chamber;
sealing the selectively sealable air intake and a selectively sealable air exhaust;
operating a vacuum system in a first vacuum mode to remove non-carbon dioxide gas from the interior while the carbon dioxide remains adsorbed by the adsorbent material;
heating, using a temperature control system thermally coupled to the carbon capture structure, the carbon capture structure to release the carbon dioxide from the adsorbent material; and
operating the vacuum system in a second vacuum mode to remove the released carbon dioxide from the interior.
